(19) United States
(12) Patent Application Publication
(10) Pub. No.: US 2026/0208266 A1
(43) Pub. Date: Jul. 23, 2026

(54) POWDER BED FUSION APPARATUS AND METHODS

(71) Applicant: RENISHAW PLC, Wotton-under-Edge, Gloucestershire (GB)

(72) Inventors: Nicholas Henry Hannaford JONES, Wotton-under-Edge (GB); Ravi Guttamindapalli ASWATHANARAYANASWAMY, Wotton-under-Edge (GB); Satyendra KUTIYAL, Wotton-under-Edge (GB); Robert James BROWN, Wotton-under-Edge (GB); Andrew FARNDELL, Wotton-under-Edge (GB)

(73) Assignee: RENISHAW PLC, Wotton-under-Edge, Gloucestershire (GB)

(21) Appl. No.: 19/137,095

(22) PCT Filed: Dec. 12, 2023
(86) PCT No.: PCT/GB2023/053198

§ 371 Date: Jun. 9, 2025

(30) Foreign Application Priority Data
Dec. 13, 2022 (GB) 2218751.2

(51) Int. Cl. B22F 10/366; B22F 10/28; B22F 10/80; B33Y 10/00; B33Y 30/00; B33Y 50/00

(52) U.S. Cl. CPC B22F 10/366; B22F 10/28; B22F 10/80; B33Y 10/00; B33Y 30/00; B33Y 50/00

(57) ABSTRACT

A powder bed fusion method including scanning a laser beam across a powder bed to melt powder of the powder bed at selected locations, the laser beam scanned along a scan path including a series of offset loops.

### FIELD OF INVENTION

This invention concerns powder bed fusion apparatus and methods and, in particular, apparatus and methods for scanning a laser beam across a powder bed to selectively melt powder to form a three-dimensional object.

### BACKGROUND

In laser powder bed fusion, a powder layer is deposited on a powder bed in a build chamber and a laser beam is scanned across portions of the powder layer that correspond to a cross-section (slice) of the workpiece being constructed. The laser beam melts or sinters the powder to form a solidified layer. After selective solidification of a layer, the powder bed is lowered by a thickness of the newly solidified layer and a further layer of powder is spread over the surface and solidified, as required.

Generally, during powder bed fusion processing, the layer thickness is about 20 μm-50 μm. Increasing the layer thickness increases the build rate but also requires increases in laser power. For a laser with a Gaussian intensity profile, increasing the laser power such that powder at the edge of a track is melted to sufficient depth can result in material in the centre of the track being vaporised and/or the formation of a deep keyhole. Collapsing of keyholes formed in the melt pool can result in porosity in the resultant consolidated material. Vaporised material can result in condensate and/or debris that affects the delivery of the laser beam to the powder bed and thus the formation of the melt pool.

US2015/0198052 A1 and US2019/0232427 A1 disclose, in order to reduce or prevent spatter, using spatial oscillation of the laser beam to direct a uniform energy density per area to powdered build material. US2019/0232427 A1 further discloses modulating the intensity of the laser beam relative to velocity of a first scanning device used to scan the laser beam. This is in recognition that, for a constant intensity, locations in the oscillation where the laser beam turns receive more energy from the laser beam because the laser beam decelerates and accelerates during the turning process. A problem with such a solution is that it requires a laser with sufficient response times and a control system to ensure that the intensity of the laser beam is modulated in synchronisation with the spatial oscillation.

US2006/0157892 A1 and US2018/0345413 A1 disclose spiral scanning strategies.

US2017/0341145 A1 discloses an additive manufacturing process including the application of laser beam stirring to each of the hatches in each layer. Circular and elliptical parameters were used. Single powder layers 40 μm thick were used. The circular or elliptical oscillations had frequencies up to and over 7500 Hz with oscillation widths down to 45 μm.

US2021/0178481 A1 discloses a modulating mirror located upstream of a scanning device. The modulating mirror is actuated by a micro-electromechanical system (MEMS) or galvanometer. The modulating mirror may impart a modulation to movement of the laser beam provided by the scanning device. The modulation may comprise a circular pattern. WO2012/229171 A1 and WO2012/229172 A1 disclose circular or ellipsoidal oscillatory motion.

US2021/0354372 A1 discloses a device for producing a three-dimensional workpiece. The device comprises an electro-optic deflector, through which the laser beam passes, the electro-optic deflector adapted to deflect the laser beam in at least one dimension in dependence on a control signal, and a scan unit arranged in the beam path of the laser beam after the electro-optic deflector. The scan unit can carry out an advance movement and superposed on the advance movement is a wobble movement of the laser beam caused by the electro-optic deflector, in the form of a closed line pattern.

WO2016/156824 A1 discloses an additive manufacturing apparatus comprising a scanner with beam steering components for directing the laser beam to desired location on a powder bed. The beam steering optics comprises two movable mirrors driven by galvanometers and a third movable mirror driven by piezoelectric actuators. The piezoelectric actuators have a faster dynamic response than the galvanometers but a smaller range of movement and are used to achieve rapid changes in movement of the laser beam in a dimension compared to the longer range of movement of the laser beam in that dimension achieved by moving the galvanometers.

### SUMMARY OF INVENTION

According to a first aspect of the invention there is provided a powder bed fusion method comprising scanning a laser beam across a powder bed to melt powder of the powder bed at selected locations, the laser beam scanned along a scan path comprising a series of offset loops.

Ones of the loops may intersect. The loops are deemed to intersect if an area irradiated by scanning the laser beam along one of the loops (determined by the 1/e² spot diameter) overlaps with an area irradiated by scanning the laser beam along one of the adjacent loops. It will be understood that the term “adjacent loops” as used herein means loops that are the immediate neighbours of the loop.

The series of loops are spatially offset in an advancing direction. The advancing direction may be a linear or curved line. The method may comprise scanning the loops sequentially in the advancing direction. The scan path may be continuous with the loops joined together, for example a prolate trochoid, or a series of separate loops, such as a series of circular paths, wherein scanning of the laser beam across the powder bed is interrupted between the scanning of each of the loops.

A frequency at which the series of loops are scanned by the laser beam may be such that, when scanning at least a portion of each of a plurality of the loops, the laser beam inputs energy into a molten or partially solidified area melted by the laser beam when scanning an earlier loop in the scan path. The earlier loop in the scan path may be a previously scanned intersecting loop, for example an adjacent loop. Accordingly, the melt pool may have dimensions that are equal to or greater, preferably greater, than dimensions of each of the loops. By inputting energy into a molten area melted by a previous pass of the laser beam a required depth of the melt pool is achieved progressively rather than through a rapid input of energy, which may undesirably vaporise material or form deep keyholes. The collapsing of keyholes formed in the melt pool can result in porosity in the resultant consolidated material. By progressively forming melt pools of the required depth (through the scanning of two or more loops of the scan path with the laser beam) thicker powder layers can be consolidated without compromising quality, such as bulk density, of the resultant consolidated material when compared to traditional vector scanning. This may be the case when an advancing speed in the advancing direction is the same as or greater than the scan speed when carrying out the traditional vector scanning. Building a part using thicker layers may reduce build time.

The frequency at which the series of loops are scanned by the laser beam may be 5 kHz or greater, preferably 10 kHz or greater and more preferably 12.5 kHz or greater. Accordingly, the laser beam will return to a point close to a point of an immediately preceding loop within 300 μs, preferably within 250 μs, more preferably within 150 μs, and yet more preferably within 100 μs. Melt pool temperature and cooling rates in laser powder bed fusion, P. Hooper, Additive Manufacturing 22 (2018) 548-559 discloses maximum cooling times for Ti6Al4V of 200 μs-300 μs. Other metal materials will also typically solidify within hundreds of microseconds; therefore, such frequencies ensure that the laser beam inputs energy into a molten or partially solidified area melted by the laser beam when scanning an earlier loop in the scan path. The fully or partially molten material more readily absorbs energy of the laser beam than solidified material. The frequency, f, may satisfy

$$f > \frac{1.5}{{T}_{s}}$$

wherein Tₛ is the time period for solidification to ensure return to a melted region within the time period for solidification.

Accordingly, for Tₛ=300 μs, the frequency would be 5 kHz. For Tₛ=150 μs, the frequency would be 10 kHz. For Tₛ=100 μs, the frequency would be 15 kHz. For typical advancing speeds, v, of greater than 0.5 m/s, and typically greater than 0.7 m/s, at such frequencies, intersection of the loops occurs. However, for the lower frequency of 5 kHz, at advancing speeds above 0.9 m/s, a longitudinal diameter of the loops in the advancing direction of around 160 μm, and diameter of the laser spot of 110 μm intersection of the loops may no longer occur, although inputting energy into a portion of a previously melted area may still occur because an extent of the melt pool may extend beyond the irradiated region.

It will be understood that the loops are not limited to circular or elliptical shapes and “diameter” as used herein refers to a length in the specified direction between two opposite points on the loop. Each loop may be a convex shape. A loop may be defined as a continuous line that extends from and to a (single) crossing point where the scan path passes over itself. The crossing point may be a point wherein the scan path passes over itself with the laser beam progressing to an area not within the loop and preferably, also the next loop in a sequence of the loops. This is to be contrasted with points where one loop intersects with another loop, the scan path passing into an area within the other loop. Furthermore, each loop may be distinct in that one loop is not formed by part of another loop (i.e. the loops do not share a part of the scan path). The loops may be a repeated shape of the scan path that is offset in the advancing direction.

An advancing speed, v, in the advancing direction may be greater than 0.5 m/s, and typically greater than 0.7 m/s. The diameter of each loop may be greater than the diameter of the laser spot, dₛₚₒₜ. The diameter, D_{loop_long}, of each loop may be at least 120% and more preferably at least 130% of the diameter of the laser spot, dₛₚₒₜ. In this way, the laser beam when located at diametrically opposed locations on the loop does not irradiate the same area. If the diameter, D_{loop_long}, of each loop is too big compared to the diameter of the laser spot, porosity could occur (although this may also be dependent on an extent of overlap between adjacent loops, as scanning along a following loop may melt previously unmelted powder if the following loop passes over a previously unmelted region of powder). The laser beam may be advanced in the advancing direction at an advancing speed of at least 0.5 m/s and preferably at least 0.7 m/s. The advancing speed may be less than 1.10 m/s. It has been found that bulk density may start to be affected at advancing speeds above 1.10 m/s. The advancing speed can be defined as a distance between corresponding points of adjacent loops (a pitch of the loops) divided by the time taken to scan between the corresponding points. A scan speed is a speed the laser beam is moved along the scan path and is faster than the advancing speed.

Typical laser spot diameters are 60 μm to 120 μm. Accordingly, the diameter of each loop may be greater than 70 μm and more preferably greater than 100 μm and even more preferably greater than 130 μm.

The frequency at which the series of loops are scanned by the laser beam may be 100 kHz or less, preferably 75 kHz or less, preferably 50 kHz or less and most preferably 40 kHz or less. It has been found that finer grains are produced at frequencies around 25 kHz (such as between 10 kHz and 40 kHz, and preferably between 12.5 kHZ and 40 kHz) compared to grains produced at 5 kHz. Such smaller grains may result in improvements in properties of the consolidated material. Furthermore, it has been found that for some materials, such as titanium alloys, the ultimate tensile strength of the resultant part is highest for frequencies around 15 kHz. In a scanner with a highly dynamic actuator, such as disclosed in WO2016/156824 A1, operating at frequencies beyond 40 kHz requires biasing means to apply high loads to the mirror to rapidly return the mirror to a neutral position. However, the application of such high loads deforms the mirror resulting in defocussing of the beam and loss of beam quality. Strengthening of the mirror reduces the frequency of the mirrors first resonant flexural mode. An electro-optic deflector, such as disclosed in US2021/0354372 A1, is disadvantageous when using high energy laser beams because absorption of the laser energy as the laser beam passes through the transmissive electro-optic deflector can result in significant heating affecting the operation of the electro-optic deflector.

The method may comprise receiving a selection of a desired microstructure, such as grain size, and determining the frequency at which the series of loops are scanned by the laser beam from the desired microstructure. For example, if the desired microstructure is for epitaxial grains, a frequency between 5 kHz and 15 kHz may be selected and preferably between 5 kHz and 10 kHz. If the desired microstructure is isotropic grains, a frequency between 10 kHz and 40 kHz may be selected and preferably between 15 kHz and 40 kHz.

The method may comprise altering a frequency of the loops as the laser beam is advanced along the scan path. For example, the frequency may be changed with changes in another parameter, such as changes in advancing speed, thickness and/or number of layers of consolidated material beneath a point being scanned, a distance to a surface of an object being formed, and/or thermal characteristics of the build determined from a thermal model. The frequency may be altered within the range between 5 kHz and 40 kHz and more preferably between 10 kHz and 40 kHz and most preferably between 15 kHz and 40 kHz. Altering the frequency may be used to alter the grains of the consolidated material. Altering the frequency may be used to control a penetration depth of the melt pool. For example, a depth of a melt pool formed after an initial pass may depend on whether the melt pool is formed above consolidated material or powder and changing a frequency of the loops may alter when further energy is added to the melt pool, enabling the depth of the melt pool to be adjusted.

The method may comprise spreading powder in layers to form the powder bed. A thickness of each layer may be greater than that which can be consolidated by melting to achieve a like bulk density, i.e. within 0.1%, using a vector scanning of the laser beam that provides the same surface fluence across a width of an irradiation track irradiated by scanning of the laser beam along the scan path. The surface fluence may be defined as the laser power divided by an irradiation track width, and scan speed (in the case of vector scanning) or advancing speed (in the case of a scan in accordance with the invention). The term “surface fluence” used herein is intended to refer to a radiant energy per unit area over the irradiation track as a result of the scan (and can be contrasted with fluence of the laser beam spot, which may be different to the surface fluence, because portions of the irradiation track may be exposed multiple times to the laser beam spot during a scan). For scanning in accordance with the first aspect of the invention, the irradiation track width is a diameter, D_{loop_perp}, of the loops in a direction perpendicular to an advancing direction plus the (1/e²) laser spot diameter (referred to herein as the “effective irradiated width”). An irradiation track is an area corresponding to the effective irradiated width displaced in the advancing direction by a length of the scan path in the advancing direction. (Typically, the irradiation track is a line shaped area, although in some embodiments the effective irradiated width may change as the laser beam advances in the advancing direction and therefore, a width of the irradiation track may change). The irradiation track may correspond to an area irradiated by the laser beam (within the 1/e² laser spot diameter) when the laser beam is scanned along the scan path. The irradiation track width for a vector scan is the (1/e²) laser spot diameter. The bulk density may be above 95% and preferably, above 99%, of the theoretical maximum bulk density for the material. Enabling melting of a layer with a lower fluence may reduce vaporised material.

The thickness of each layer may be at least 10%, preferably at least 20% and more preferably at least 30% more than a maximum layer thickness that can be melted to achieve a like bulk density, i.e. within 0.1%, using a vector scanning of the laser beam that provides the same surface fluence across the same track width (as the scan in accordance with the invention).

The layer thickness may be 80 μm or more, 100 μm or more, or 120 μm or more. The layer thickness may be 80 μm or more, 100 μm or more, or 120 μm or more. The resulting consolidated material may have a bulk density above 95% and preferably, above 99%, of the theoretical maximum bulk density for the material.

An energy density value for the average surface fluence across the track width divided by layer thickness may be less than 30 J/mm³, more preferably, less than 25 J/mm³ and more preferably less than 20 J/mm³.

The powder material may be a metal.

The powder material may be titanium or a titanium alloy, and the layer thickness may be greater than 120 μm. The powder material may be titanium or a titanium alloy, the layer thickness may be greater than 120 μm and resulting consolidated material may have a bulk density above 95% and preferably, above 99%, of the theoretical maximum bulk density for the material. The powder material may be titanium or a titanium alloy and the energy density value for the average surface fluence across the track width divided by layer thickness may be less than 30 J/mm³, more preferably less than 25 J/mm³, even more preferably less than 20 J/mm³, and yet more preferably less than 15 J/mm³. The average surface fluence across the track width may be below 4.0 J/mm². The average surface fluence across the track width may be above 1.5 J/mm². Resulting consolidated material may have a bulk density above 95% and preferably, above 99%, of the theoretical maximum bulk density for the material. The titanium alloy may be Ti6Al4V, CP-Ti, Ti5553, or Ti6242. The titanium alloy may be grade 23 or grade 5 Ti6Al4V.

The powder material may be aluminium or an aluminium alloy, and the layer thickness may be greater than 80 μm. The powder material may be aluminium or an aluminium alloy, the layer thickness may be greater than 80 μm and resulting consolidated material may have a bulk density above 95% and preferably, above 99%, of the theoretical maximum bulk density for the material. The powder material may be aluminium or an aluminium alloy and the energy density value of average surface fluence across a width the track divided by layer thickness may be less than 30 J/mm³, more preferably less than 25 J/mm³, more preferably less than 20 J/mm³ and even more preferably less than 15 J/mm³. Resulting consolidated material may have a bulk density above 95% and preferably, above 99%, of the theoretical maximum bulk density for the material. The aluminium alloy may be AlSi10Mg, AlSi7Mg, Al356, Al357, AlSi12, Al2024, Al6061, Al7075, A20x or Scalmalloy.

The powder material may be a nickel alloy. The powder material may be a nickel-chromium-molybdenum alloy. The powder material may be a nickel-chromium-molybdenum alloy and the layer thickness may be greater than 120 μm. The powder material may be a nickel-chromium-molybdenum alloy, the layer thickness may be greater than 120 μm, and resulting consolidated material may have a bulk density above 95% and preferably, above 99%, of the theoretical maximum bulk density for the material. The powder material may be a nickel-chromium-molybdenum alloy and an energy density value of average surface fluence across a width the track divided by layer thickness may be less than 30 J/mm³, more preferably less than 25 J/mm³, more preferably less than 20 J/mm³ and even more preferably less than 15 J/mm³. The nickel-chromium-molybdenum alloy may be Inconel (such as Inconel 718, Inconel 625 and Inconel 939), Haynes 282 or Hastelloy.

The powder material may be a steel, in particular, a stainless steel. The powder material may be steel and the layer thickness may be greater than 120 μm. The powder material may be steel, the layer thickness may be greater than 120 μm, and resulting consolidated material may have a bulk density above 95% and preferably, above 99%, of the theoretical maximum bulk density for the material. The powder material may be steel and an energy density value of average surface fluence across a width the track divided by layer thickness is less than 30 J/mm³, more preferably less than 25 J/mm³, and even more preferably less than 20 J/mm³. The steel may be 316L stainless steel.

It has been realised that scanning the laser beam in a continuous scan path comprising a series of offset loops, wherein ones of the loops may intersect, enables layers to be processed at a lower surface fluence. Such a scan provides more “headroom” for turning up the laser parameters to process thicker layers whilst achieving like-material properties.

Scanning the laser beam across the powder bed to melt powder of the powder bed at selected locations may comprise scanning the laser beam along a first scan path and a second scan path, wherein each of the first and second scan path comprise a series of offset loops, wherein ones of the loops intersect, the loops of the first scan path spatially offset in a first advancing direction and the loops of the second scan path spatially offset in a second advancing direction parallel to the first advancing direction, and loops of the first scan path intersecting with loops of the second scan path. The method may comprise scanning the loops of the first scan path sequentially in the first advancing direction and scanning the loops of the second scan path sequentially in the second advancing direction.

A track overlap between a first one of the scan paths carried out on a powder layer and a second one of the scan paths carried out on the powder layer may be at least 10%, preferably at least 20%, and more preferably at least 30% of an effective irradiated width of at least one of the first and second scan paths. The track overlap may be less than 70% of the effective irradiated width of at least one of the first and second scan paths. The track overlap may be less than 40% of the effective irradiated width of at least one of the first and second scan paths. It has been found that the resultant grains transform to epitaxial from isotropic if the track overlap is above 40% of the effective irradiated width. Alternatively, the track path overlap may be more than 40% of the effective irradiated width of at least one of the first and second scan paths. In certain circumstances, epitaxial grains may be a desirable outcome.

An overlap between effective irradiated regions of adjacent loops may be at least 5%, preferably at least 20%, more preferably at least 40% and most preferably at least 50% of an effective irradiated length of the effective irradiated region. The effective irradiated region of a loop is a diameter of the loop in the advancing direction plus the spot diameter. The overlap between the effective irradiated region of adjacent loops may be less than 90% of the effective irradiated length.

The laser beam may be scanned along the scan path to form a melt pool having a width (in a direction perpendicular to the advancing direction) greater than a width of the loops.

The laser beam may be scanned along the scan path to form a melt pool in conduction or transition mode. It will be understood that “conduction mode” as used herein means that the energy of the energy beam is coupled into the powder bed primarily through heat conduction creating a melt pool having a width greater than its depth. This is to be contrasted with keyhole mode in which a hole is formed in the melt pool where material is vaporised by exposure to the energy beam. A melt pool formed in keyhole mode has a deep, narrow profile with a ratio of depth to width (in a direction perpendicular to the advancing direction) of greater than 1.5. A transition mode exists between the conduction mode and the keyhole mode, wherein the energy does not dissipate quickly enough, and the processing temperature rises above the vaporisation temperature. A depth of the melt pool increases, and penetration of the melt pool can start. Preferably, the method comprises exposing the layer to the or each energy beam to form melt pools in a conduction or transition mode having a depth to width ratio of less than 1.5, preferably, less than 1, more preferably less than 0.75 and most preferably less than or equal to 0.5.

The method may comprise altering a diameter (amplitude) of the loops as the laser beam is advanced along the scan path. For example, the diameter may be changed with changes in another parameter, such as changes in advancing speed, thickness and/or number of layers of consolidated material beneath a point being scanned, a distance to a surface of an object being formed, and/or thermal characteristics of the build determined from a thermal model. Changing diameters of the loops may alter a surface fluence of the laser beam along the track and width, depth and/or orientation of the melt pool. The diameter may be a diameter of the loop transverse, and in particular perpendicular, to the advancing direction. For example, it may be advantageous to change the diameter of the loop transverse to the advancing direction to change a width of the track. This be beneficial for forming small dimensional changes in a surface of the part. Accordingly, the method may remove the need for border scans that trace the surface contour(s) of the part for each layer. Altering a diameter of the loops may alter a circularity of the loops. For example, the change in diameter may be along a first axis whereas a diameter along a second axis, which may be perpendicular to the first axis, may remain unchanged. Alternatively, the alteration in diameter may be applied uniformly to the loop in all directions such that the loop is scaled but the circularity remains unchanged.

A major axis of each loop may be transverse to the advancing direction, for example, such that a melt pool is formed having a longitudinal axis inclined to the advancing direction. For example, a melt pool direction along the longitudinal axis from the rear to the front of the melt pool may between 0° and 90° and 270° and 360° to the advancing direction. A major axis of each loop may be between 0° and 90° and 270° and 360° to the advancing direction. The track defined by the scan path may bisect an area to be consolidated, wherein a first portion of the area on one side the track is predicted to be at a higher temperature than a second portion of the area the other side of the track and an orientation of the major axis of each loop of the scan path is such that a melt pool direction along the longitudinal axis from the rear to the front of the melt pool is directed away from the first portion. In this way, the front of the melt pool is surrounded by cooler material and will cool more quickly, which can have advantages for solidification cracking and/or isotropic grain formation. A first portion of the area on one side the track may be predicted to be at a higher temperature than a second portion of the area from a thermal model, because the first portion has a smaller area than the second portion, because the first portion has fewer connections or a smaller area connected to consolidated material of lower layers than the second portion and/or because the track lengths for the first portion are, on average, smaller than the track lengths of the second portion. The melt pool direction may be set by a ratio of the major and minor axis of the loop. The method may comprise selecting the ratio of the major to the minor axis for a desired melt pool direction. An orientation of the major axes of the loops may be varied along the scan path. For example, a desired orientation of the major axes may change dependent on changes in the temperatures either side of the track.

A major axis of a or each loop may be aligned with an advancing direction of the scan path. Extending the or each loop in the advancing direction may create a longer, thinner melt pool having a larger surface area than a melt pool formed with a loop that is closer to a circle and may reduce overlap of the melt pool with a melt pool of an adjacent track. This may increase the cooling rate of the melt pool, which may have advantages in the microstructure, such as grains, which are formed and/or as a means to mitigate the effects of heat build-up in areas of a part having poorer conduction to other areas of the part. The major axis may be 20%, 50% or 100% larger than a minor axis of the loop. The major axis may be at least 20%, 50% or 100% larger than a minor axis of the loop.

The method may comprise selecting a shape of the loops based on a direction of gas flow across the powder bed. The method may comprise selecting a direction of a major axis of the or each loop based on the gas flow direction. The method may comprise selecting a major axis of the or each loop to be at an angle of between-45° and +45° to the gas flow direction. This may result in a shallower melt pool, which may be desirable for certain areas of the part, such as areas deemed to be downskin areas. Downskin areas are regions with no or only a few layers of solidified material directly underneath such that solidified material formed by melting the area forms a surface of the part. Downskin areas may be defined as areas having a number of layers directly underneath below a predetermined threshold. The predetermined threshold may be 10, 9, 8, 7, 6, 5, 4, 3, 2 or 1 layers. Alternatively, the method may comprise selecting a major axis of the or each loop to be at an angle of between +45° and +135° to the gas flow direction. This may result in a deeper melt pool, which may be desirable for certain areas of the part, such as areas deemed to be volume areas. Volume areas may be defined as areas having a number of layers directly underneath equal to or above the predetermined threshold. The method may comprise scanning the laser beam over a layer along a plurality of the scan paths, wherein, for first ones of the scan paths within a volume area of the layer, a major axis of each loop is at an angle of between +45° and +135° to the gas flow direction and, for second ones of the scan paths within a downskin area of the layer, a major axis of the or each loop is at an angle of between −45° and +45° to the gas flow direction. The method may comprise a border scan path around a periphery of an area to be solidified in the layer, wherein a major axis of each loop of the border scan is at an angle of between −45° and +45° to the gas flow direction for parts of the border scan around a volume area and, a major axis of each loop is between +45° and 135° to the gas flow direction for parts of the border scan around a downskin area.

The gas flow may be generated between a gas nozzle and gas exhaust. The gas flow direction may be a direction of gas flow from the gas nozzle to the gas exhaust. The gas nozzle may be located on one side of the powder bed and the gas exhaust located on an opposite side of the powder bed. The gas flow direction may be from the side of the powder bed on which the gas nozzle is located to the opposite side of the powder bed on which the gas exhaust is located.

The method may comprise scanning the laser beam over a layer along a plurality of the scan paths, wherein, for first ones of the scan paths within a volume area of the layer, a major axis of each loop is at an angle of between −45° and +45° to the advancing direction and, for second ones of the scan paths within a downskin area of the layer, a major axis of the or each loop is between +45° and 135° to the advancing direction.

The method may comprise altering an amplitude of an oscillation of a movable steering optic of a scanner that directs the laser beam to the powder bed to compensate for an angle of the laser beam to a plane of the powder layer/working plane such that a diameter of the loops in a direction in which the laser beam has moved away from the perpendicular (to a plane of a surface of the powder bed) remains unchanged for changes in the angle of the laser beam to a plane of the powder layer/working plane. Without compensation, the shape of the loop will become stretched in the direction in which the laser beam has moved away from the perpendicular. Suitable adjustments to the movement of the steering optics can compensate for this effect.

The method may comprise altering an intensity of the laser beam as the laser beam is scanned around a one (at least one) of the loops. For example, the intensity may be changed with changes in another parameter, such as changes in advancing speed, thickness and/or number of layers of consolidated material beneath a point being scanned, a distance to a surface of an object being formed, and/or thermal characteristics of the build determined from a thermal model. The intensity of the laser beam may be altered by changing a power of the laser beam. The intensity of the laser beam may be altered by changing a spot size of the laser beam on the powder bed, for example by altering a focal distance of the laser beam relative to a plane of the powder bed (a working plane).

A higher intensity laser beam may be used for a first portion of a loop closer (in a direction in the plane of the powder layer/working plane) to powder and a lower intensity laser beam may be used for a second portion of the loop closer to previously consolidated (solidified) material. For example, material consolidated by a previous scan of the laser beam along another track may be located one side of the scan path, whereas powder may be located on another (the other) side of the track. More energy may be required to melt (relatively cold) powder compared to (relatively hot) solidified material recently melted by the previous scan.

A higher intensity laser beam may be used for outer portions of each loop further from a central axis of the track and a lower intensity laser beam may be used for central portions of each loop closer to the central axis. The central axis is a line in the advancing direction located midway between the extremes of each loop perpendicular to the advancing direction. By using a higher intensity laser beam for the outer portions, a U-shaped (or cow-horn) surface fluence profile may be achieved across the track perpendicular to the advancing direction. Such a U-shaped surface fluence profile may be advantageous as it may result in a more uniform (closer to flat-top) temperature profile across the track. In particular, applying an equal energy (top hat profile) across the loop may result in a temperature peak in a central region of the track as a central region may cooler more slowly relative to the outside regions, which are closer to unmelted areas that are at a much lower temperature. Inputting more energy into the outside regions ensures that the outside regions are melted whilst the central regions are kept below a temperature that would vaporise significant amounts of material. Such a U-shaped surface fluence may also be formed by using a laser beam having a fixed laser intensity for all portions of each loop. This may achieved by selecting appropriate ratios between perpendicular amplitudes for the loops, laser spot diameter, frequency and advancing speed.

A lower intensity laser beam may be used for outer portions of each loop further from a central axis of the track and a higher intensity laser beam may be used for central portions of each loop closer to the central axis. A lower intensity laser beam may be used for outer portions of each loop further from a central axis of the track and a higher intensity laser beam may be used for central portions of each loop closer to the central axis such that a flat-topped surface fluence is achieved perpendicularly across the track.

Ratios between perpendicular amplitudes for the loops, laser spot diameter, frequency and advancing speed may be such that a flat-topped surface fluence is achieved perpendicularly across the track.

A higher intensity laser beam may be used for a fore stroke of at least one and preferably each of the loops and a lower intensity laser beam for a rear (aft) stroke of the at least one or each of the loops. The fore stroke is a portion of the loop in front of the rear stroke in the advancing direction. The fore and/or the rear stroke may include movement of the laser beam in the advancing direction and movement of the laser beam in a direction opposed to the advancing direction. The fore stroke may be a portion of the loop wherein the laser beam irradiates a region of the powder bed not previously irradiated by the movement of the laser beam along the scan path. The fore stroke may be a first portion of the scan path that is not within a previously scanned loop and the rear stroke may be a second portion within a previously scanned loop. It has been found that applying a constant intensity laser beam to the loop can result in a track of consolidated material with an inconsistent height and/or width. In particular, a wavy surface to the track of consolidated material has been observed when using a constant laser intensity. By varying the laser beam intensity between the fore stroke and the rear stroke, a more uniform surface to the track of consolidated material has been observed.

The method may comprise altering an advancing speed along the track. Altering the advancing speed for a fixed frequency will alter the pitch between adjacent loops, and therefore the overlap between irradiated regions for adjacent loops.

The method may comprise altering the average energy density value (surface fluence divided by layer thickness) between a first one of the scan paths carried out on a first layer and a second one of the scan paths carried out on a second layer, immediately succeeding the first layer. Both the first and second ones of the scan paths may be hatch lines of a plurality of parallel hatch lines used to consolidate material in the first and second layers. There may be a plurality of first ones of the scan paths carried out on the first layer and a plurality of second ones of the scan paths carried out on the second layer. For example, all hatch lines of the first layer may be first ones of the scan paths having a first average energy density value and all hatch lines of the second layer may be second ones of the scan paths having a second average energy density value different to the first energy density value. It has been found that that as the surface fluence is increased with increases in layer thickness, residual stresses in the resultant part increase.

The method may comprise controlling the laser power based on a steering optic control signal sent to an actuator for moving steering optics of a scanner that directs the laser beam to different locations on the powder bed or an encoder signal that measures a position of the steering optics. The method may comprise deriving a laser control signal (sent to a laser) to control the laser power of the laser beam from the steering optic control signals or encoder signals. The steering optics may comprise a movable optic controlled by a second actuator that has a faster dynamic response than a first actuator for moving the or another steering optic for moving the laser beam across the powder bed. The steering optic control signal may be a direct drive signal for driving the second actuator. The encoder signal may be from an encoder for measuring a position of a steering optic driven by the second actuator. The second actuator may at least one piezoelectric actuator. The first actuator may be a galvanometer. The steering optic may be a mirror. The other steering optic may be a mirror. The second actuator may comprise two or more actuator elements, such as two or more piezoelectric stacks, which operate together to define a position of the steering optic and the method may comprise deriving a laser control signal from steering optic control signals sent to each actuator element. The scanner may be a scanner as described in WO2016/156824 A1, which is incorporated herein in its entirety by reference. For example, to form the loop, the steering optic driven by the second actuator may be driven to cause the laser beam to be scanned in a circle or ellipse on the powder bed, wherein movement of the first actuator superimposed on this circular or elliptical motion of the laser beam results in the scan path comprising a series of offset loops, wherein ones of the loops intersect. By deriving the laser control signals from the steering optic drive signals sent to each actuator element, changes in the laser power can be synchronised with the circular or elliptical motion. In this way, the steering optics becomes the “master” of the laser power, such that a desired laser power profile can be derived from the steering optic control signal for each repeated cycle of the steering optic.

According to a second aspect of the invention there is provided a powder bed fusion method comprising scanning a laser beam across a powder bed to melt powder of the powder bed at selected locations using a scanner having a first actuator arranged to move a movable optic for directing the laser beam to different locations on the powder bed and a second actuator arranged to move the or another movable steering optic for directing the laser beam to different locations on the powder bed, wherein the second actuator has a faster dynamic response than the first actuator. The method may comprise scanning the laser beam across a powder bed using the scanner such that the laser beam is moved in a first direction as a result of movement of the first actuator and the second actuator is oscillated to oscillate the laser beam in a second direction transverse to the first direction.

The method may comprise altering a frequency of the oscillations as the laser beam is advanced by the first actuator. For example, the frequency may be changed with changes in another parameter, such as changes in advancing speed of the laser beam achieved using the first actuator, thickness and/or number of layers of consolidated material beneath a point being scanned, a distance to a surface of an object being formed, and/or thermal characteristics of the build determined from a thermal model. The frequency may be altered between 5 kHz and 40 kHz and more preferably between 10 kHz and 40 kHz and most preferably between 12.5 kHz and 40 kHz. Altering the frequency may be used to alter the grains of the consolidated material. Altering the frequency may be used to control a penetration depth of the melt pool. For example, a depth of a melt pool formed after an initial pass may depend on whether the melt pool is formed above consolidated material or powder and changing a frequency of the oscillations may enable the depth of the melt pool to be adjusted.

The method may comprise altering an amplitude of the oscillations as the laser beam is advanced by the first actuator. For example, the amplitude may be changed with changes in another parameter, such as changes in advancing speed of the laser beam achieved using the first actuator, thickness and/or number of layers of consolidated material beneath a point being scanned, a distance to a surface of an object being formed, and/or thermal characteristics of the build determined from a thermal model. Changing the amplitude of the oscillations may alter a surface fluence of the laser beam along a track and width and/or depth of the melt pool. Changing an amplitude of the oscillations may be beneficial for forming dimensional changes in a surface of the part at a resolution smaller than a track width using hatch scanning techniques. Accordingly, the method may remove the need for border scans that trace the surface contour(s) of the part for each layer.

The method may comprise altering an amplitude of an oscillation of a movable steering optic of a scanner that directs the laser beam to the powder bed to compensate for an angle of the laser beam to a plane of the powder layer/working plane such that an amplitude of the oscillations in a direction in which the laser beam has moved away from the perpendicular remains unchanged for changes in the angle of the laser beam to a plane of the powder layer/working plane. Without compensation, the amplitude of the oscillations will become stretched in the direction in which the laser beam has moved away from the perpendicular. Suitable adjustments to the movement of the steering optics can compensate for this effect.

The method may comprise altering an intensity of the laser beam during at least one and preferably each period of a plurality of periods of the oscillation. For example, the intensity may be changed with changes in another parameter, such as changes in advancing speed of the laser beam achieved using the first actuator, thickness and/or number of layers of consolidated material beneath a point being scanned, a distance to a surface of an object being formed, and/or thermal characteristics of the build determined from a thermal model. The intensity of the laser beam may be altered by changing a power of the laser beam. The intensity of the laser beam may be altered by changing a spot size of the laser beam on the powder bed, for example by altering a focal distance of the laser beam relative to a plane of the powder bed (a working plane).

A higher intensity laser beam may be used for a first portion of the period closer (in a direction in the plane of the powder layer/working plane) to powder and a lower intensity laser beam may be used for a second portion of the period closer to previously consolidated (solidified) material. For example, material consolidated by a previous scan of the laser beam along another track may be located one side of the track, whereas powder may be located on another (the other) side of the track. More energy may be required to melt (relatively cold) powder compared to (relatively hot) solidified material recent melted by the previous scan.

A higher intensity laser beam may be used for outer portions of each period further from a central axis of a track and a lower intensity laser beam may be used for central portions of each period closer to the central axis. The central axis is a line in an advancing direction of the laser beam achieved using the first actuator located midway between the extremes of each period perpendicular to the advancing direction. By using a higher intensity laser beam for the outer portions, a U-shaped (or cow-horn) intensity profile may be achieved across the track perpendicular to the advancing direction. Such a U-shaped intensity profile may be advantageous as it may result in a more uniform (closer to flat-top) temperature profile across the track. In particular, applying an equal energy (top hat profile) across the loop may result in a temperature peak in a central region of the track as heat will not flow as quickly away from a central region relative to the outside regions, which are closer to unmelted areas that are at a much lower temperature. Inputting more energy into the outside regions ensures that the outside regions are melted whilst the central regions are kept below a temperature that would vaporise significant amounts of material.

The method may comprise altering an advancing speed of the laser beam achieved using the first actuator. Altering the advancing speed for a fixed frequency will alter the pitch between adjacent periods, and therefore the overlap between irradiated regions for adjacent periods.

According to a third aspect of the invention there is provided a powder bed fusion method comprising scanning a laser beam across a powder bed to melt powder of the powder bed at selected locations using a scanner, and controlling the laser power of the laser beam based on a steering optic control signal sent to an actuator for moving steering optics of the scanner or an encoder signal that measures a position of the steering optics. The method may comprise deriving a laser control signal (sent to a laser) to control the laser power of the laser beam from the steering optic control signals or encoder signals. The steering optics may comprise a movable optic controlled by a second actuator that has a faster dynamic response than a first actuator for moving the or another steering optic for moving the laser beam across the powder bed. The steering optic control signal may be a direct drive signal for driving the second actuator. The encoder signal may be from an encoder for measuring a position of a steering optic driven by the second actuator. The second actuator may at least one piezoelectric actuator. The first actuator may be a galvanometer. The steering optic may be a mirror. The other steering optic may be a mirror. The second actuator may comprise two or more actuator elements, such as two or more piezoelectric stacks, which operate together to define a position of the steering optic and the method may comprise deriving a laser control signal from steering optic control signals sent to each actuator element. The scanner may be a scanner as described in WO2016/156824 A1, which is incorporated herein in its entirety by reference. For example, the steering optic driven by the second actuator may be driven to perform an oscillating motion, wherein movement of the first actuator superimposed on this oscillating motion results in a scan path comprising a series of oscillations of the laser beam superimposed on an advancement of the laser beam in an advancing direction. The oscillations of the laser beam may be in a direction transverse to and/or in-line with the advancing direction. By deriving the laser control signals from the steering optic drive signals sent to each actuator element, changes in the laser power can be synchronised with the oscillating motion. In this way, the steering optics becomes the “master” of the laser power, such that a desired laser power profile can be derived from the steering optic control signal for each repeated cycle of the steering optic.

According to a fourth aspect of the invention there is provided a powder bed fusion method comprising controlling a steering optic to perform cyclical motion to scan a laser beam across a powder bed to melt powder of the powder bed. The method may comprise cycling laser power of the laser beam with the same period as and synchronised with the cyclical motion of the steering optic.

Cycling of the laser power may be based on a steering optic control signal sent to an actuator for moving steering optics of the scanner or an encoder signal that measures a position of the steering optics.

The cyclical motion of the steering optic may be defined by set positions of the steering optics for different temporal segments of the cyclical motion. Cycling of the laser power may be defined by laser powers for the different temporal segments of the cyclical motion. A length of the temporal segments may be defined by the period of the cyclical motion and the length is altered if the period is changed. For example, the period of the cyclical motion may be defined by a desired frequency, such a desired frequency of the loops defined in the first aspect of the invention, and changing the frequency changes the period and therefore the length of the temporal segments. However, a relationship between the position of the steering optic and the laser power will remain the same. In this way, a desired relationship between position of the steering optic and the laser power is maintained for different frequencies of the cycle.

According to a fifth aspect of the invention there is provided a powder bed fusion apparatus comprising a scanner for directing a laser beam to selected regions of a powder bed and a controller for controlling the scanner, the controller arranged to control the scanner to carry out the powder bed fusion method according to the first, second, third or fourth aspect of the invention.

According to a sixth aspect of the invention there is provided a data carrier having instructions thereon, wherein, when the instructions are executed by a controller of a powder bed fusion apparatus, the instructions cause the controller to control a scanner to carry out the powder bed fusion method according to the first, second, third or fourth aspect of the invention.

The data carrier of the above aspects of the invention may be a suitable medium for providing a machine with instructions such as non-transient data carrier, for example a floppy disk, a CD ROM, a DVD ROM/RAM (including −R/−RW and +R/+RW), an HD DVD, a Blu Ray™ disc, a memory (such as a Memory Stick™, an SD card, a compact flash card, or the like), a disc drive (such as a hard disc drive), a tape, any magneto/optical storage, or a transient data carrier, such as a signal on a wire or fibre optic or a wireless signal, for example a signals sent over a wired or wireless network (such as an Internet download, an FTP transfer, or the like).

### DESCRIPTION OF DRAWINGS

FIG. 1 is a schematic of a laser powder bed fusion apparatus according to an embodiment of the invention;

FIG. 2 is a schematic of the laser powder bed fusion apparatus from another side;

FIG. 3 is a schematic diagram of a scanner according to one embodiment of the invention;

FIG. 4 shows a scan path in accordance with an embodiment of the invention;

FIG. 5 shows a scan path in accordance with another embodiment of the invention;

FIG. 6 shows a scan path in accordance with an embodiment of the invention wherein a wavelength of the oscillations of the scan path is less than a diameter of each loop in the longitudinal direction;

FIG. 7 shows a scan path in accordance with an embodiment of the invention wherein a wavelength of the oscillations of the scan path is approximately equal to a diameter of each loop in the longitudinal direction;

FIG. 8 shows a scan path in accordance with an embodiment of the invention wherein a wavelength of the oscillations of the scan path greater than a diameter of each loop in the longitudinal direction;

FIG. 9 shows first and second scan paths, wherein effective irradiation regions (tracks) of the first and second scan paths overlap;

FIG. 10 is a graph of a value of average surface fluence (2D energy density—2DED) divided by layer thickness versus layer thickness for vector scans and trochoidal scans (referred to as “wobble” scans) for different materials;

FIG. 11 is a table showing the scan parameters used for each scan plotted in the graph of FIG. 10, the build rate and the resultant drop in 2DED for the wobble scans compared to the corresponding vector scans;

FIG. 12 is a schematic illustration of melting of powder material with a laser beam using vector scanning;

FIG. 13 is a schematic illustration of melting of powder material with a laser beam using trochoidal (wobble) scanning;

FIGS. 14(a) to (d) are cross-sectional images of single tracks formed using different scans, and melt pool depth measurements: (a) no wobble, (b) 12.5 kHz, (c) 18.75 kHz and (d) 25 kHz;

FIGS. 15(a) to (e) are cross-sectional images of solidified material consolidated using trochoidal scans at different frequencies and FIG. 15(f) is a table showing the melt pool depths measured at each frequency;

FIGS. 16(a) to (f) are cross-sectional images in the X-Y plane of Al6061 material solidified using the trochoidal scans at each of the different frequencies;

FIG. 17a is a table illustrating material densities and hardness achieved at different advancing speeds for trochoidal scanning and FIG. 17b is a table of the scan parameters used to achieve such advancing speeds and the resultant 2DED;

FIGS. 18a and 18b are images of condensate captured during vector scanning (FIG. 18a) and trochoidal scanning (FIG. 18b);

FIG. 19 is a graph of particle count with layer number for vector scanning and trochoidal scanning;

FIG. 20 shows a scan path of loops of different diameters according to an embodiment of the invention;

FIG. 21 shows a scan path of elliptical loops, each loop with its major axis aligned in the advancing direction according to an embodiment of the invention;

FIG. 22a shows a scan path of elliptical loops, each loop with its major axis transverse to the advancing direction according to an embodiment of the invention;

FIG. 22b is a schematic showing different orientations of elliptical loops relative to gas flow used to form five different samples, wherein i) is 90° to a direction antiparallel to a gas flow direction, ii) is 60° to a direction antiparallel to a gas flow direction, iii) is 45° to a direction antiparallel to a gas flow direction, iv) is 30° to a direction antiparallel to a gas flow direction, and v) is 0° to a direction antiparallel to a gas flow direction;

FIG. 22c are images of the samples produced using the orientations of elliptical loops shown in FIG. 22b, wherein samples (i) to (v) correspond respectively to orientations (i) to (v).

FIG. 22d is an image and table illustrating the melt pool depth and width achieved at different orientations of the major axis relative a gas flow direction;

FIG. 22e is an arrangement of scan paths comprising elliptical loops according to an embodiment of the invention, wherein an advancing direction of the scan paths is 90° to a gas flow direction;

FIG. 22f is an arrangement of scan paths comprising elliptical loops according to an embodiment of the invention, wherein an advancing direction of the scan paths is 0° to a gas flow direction;

FIG. 22g is an arrangement of scan paths comprising elliptical loops according to an embodiment of the invention, wherein an advancing direction of the scan paths is 45° to a gas flow direction;

FIG. 23 shows examples of how the scan paths shown in FIGS. 18 to 20 may be oriented in respect of a narrowing area to be solidified;

FIG. 24 shows a scan path of loops, wherein a laser power of the laser beam is changed for a rear stroke of each loop compared to a laser power used for a fore stroke of the loop;

FIG. 25 shows a surface fluence profile perpendicular to the advancing direction of the scan path for a 25 kHz trochoidal scan, wherein the laser power remains the same for all regions of each loop;

FIG. 26 shows a surface fluence profile perpendicular to the advancing direction of the scan path for a 5 kHz trochoidal scan, wherein the laser power remains the same for all regions of each loop;

FIG. 27a shows a surface fluence profile perpendicular to the advancing direction of the scan path for a 25 kHz trochoidal scan, wherein the laser beam has been defocussed to have twice the diameter to that shown in FIG. 25;

FIG. 27b shows a surface fluence profile perpendicular to the advancing direction of the scan path for a 25 kHz trochoidal scan, wherein the laser power is varied during a cycle of the fast (piezoelectric actuated) mirror;

FIG. 27c shows a surface fluence profile perpendicular to the advancing direction of the scan path for a 25 kHz trochoidal scan, wherein an amplitude of the loops perpendicular to the advancing direction has been increased compared to that shown in FIG. 25;

FIG. 28 is a surface fluence profile perpendicular to the advancing direction of the scan path for a trochoidal scan, wherein the laser power is varied to be higher for one side of each loop compared to the other side of the loop;

FIG. 29 is a schematic diagram of a piezo controller according to an embodiment of the invention;

FIG. 30 is a schematic diagram of a piezo controller and power demand profiler according to another embodiment of the invention;

FIG. 31 is a graph showing steering optic control signals for a piezoelectric actuated mirror and laser control signals for a laser that is derived from the steering optic control signals;

FIG. 32 is a graph showing an alternative laser power control regime, wherein a cycle time for the control signals for the piezoelectric actuators and demand signal for laser power is divided into a plurality of segments; and

FIG. 33 is a diagram illustrating variables that may be altered in combination to affect the resultant solidified material.

### DESCRIPTION OF EMBODIMENTS

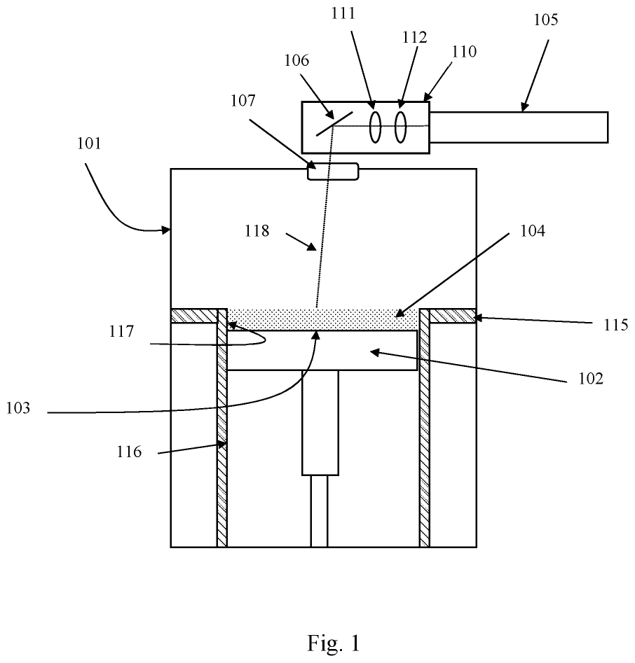

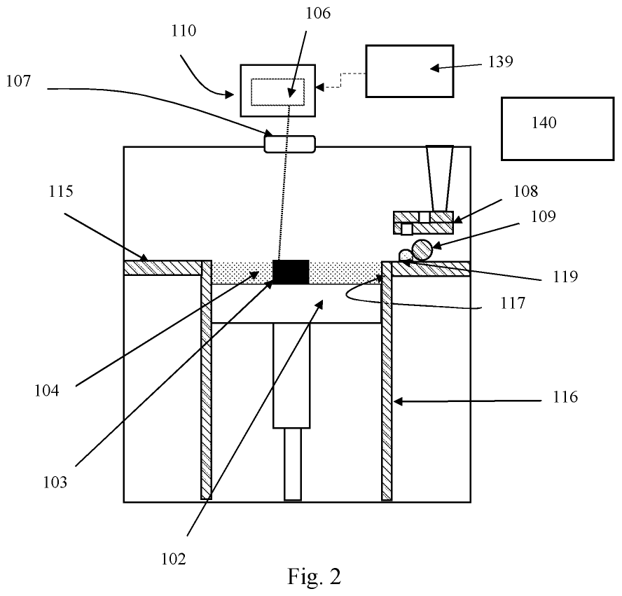

Referring to FIGS. 1 and 2, a laser powder bed fusion apparatus according to an embodiment of the invention comprises a main chamber 101 having therein a processing plate 115 and build sleeve 116 that defines a build volume 117. A build platform 102 is lowerable in the build volume 117 and provides a surface for supporting a powder bed 104 and part 103 built by selective laser melting the powder. The platform 102 is lowered within the build chamber 117 as successive layers of the part 103 are formed.

Layers of powder 104 are formed as the object 103 is built by dispensing apparatus 108 and an elongate wiper 109. For example, the dispensing apparatus 108 may be apparatus as described in WO2010/007396. The lower edge of the wiper 109 defines a working plane 110 to which a laser beam 118 is directed.

A laser module 105 generates a 500W laser for melting the powder 104, the laser directed as required by a scanner, in this embodiment an optical module 110. The laser enters the chamber 101 via a window 107.

The optical module 110 comprises beam steering components 106 for directing the laser beam 118 to the desired location on the powder bed 104 and focussing optics, in this embodiment a pair of movable lenses 111, 112, for adjusting a focal length of the laser beam. Actuators of the beam steering components 106 and focussing optics 111, 112 are controlled by a controller 139 of the optical module 110.

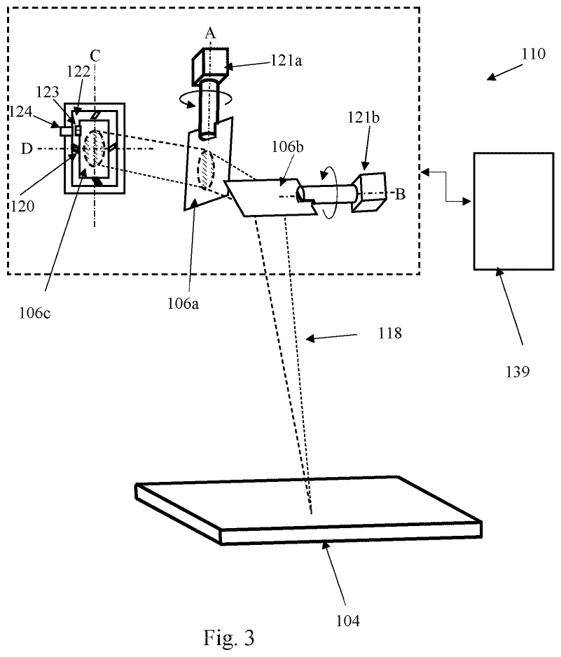

Referring to FIG. 3, in one embodiment, the beam steering components 106 comprise two movable mirrors 106a, 106b driven by galvanometers 121a, 121b and a third movable mirror 106c driven by an actuator having a faster dynamic response than the galvanometers 121a, 121b. In this embodiment, the actuator is a piezoelectric actuator 120. Mirror 106a is rotatable about an axis A perpendicular to an axis B about which mirror 106b can be rotated, and the third movable mirror 106c is steerable about two perpendicular axes C, D. The mirrors 106a, 106b and 106c are arranged such that the laser passes through the focussing optics 111, 112 to mirror 106c, which deflects the laser on to mirror 106a. Mirror 106a deflects the laser onto mirror 106b and mirror 106b deflects the laser out of the optical module through a window or opening to the powder bed 104.

The piezoelectric actuator 120 is operable to rotate the mirror 106c by a few degrees in a direction about axis C and to rotate the mirror 160c by a few degrees in a direction about an axis D. The piezoelectric actuator 120 provides a faster dynamic response (acceleration) than the galvanometers 121a, 121b but a smaller range of movement. The mirror 106c can be used to deflect the laser beam through a range of angles in the same dimensions as can be achieved with mirrors 106a and 106b. Typically, each galvanometer 121a, 121b will be capable of moving the associated mirror 106a, 106b through a range of angles about axis A, B of +/−10 degrees, although a range of angles of up to +/−20 degrees could be used. The piezoelectric actuator 120 will typically be capable of steering mirror 106c through a range of angles about axes C and D that is approximately 1% of the range of mirrors 106a, 106b.

The piezoelectric actuator typically comprises a plurality of independently driven piezoelectric stacks. More details of the piezoelectric actuator are described in WO2016/156824 A1, which is incorporated herein in its entirety by reference.

Appropriate circuitry is connected to the piezoelectric stacks to apply appropriate drive voltages to the stacks to control extension and contraction of the stacks.

The actuators 120, 121a and 121b are controlled by controller 139 of the optical module 106. The controller 139 generates a drive (control) signal for each actuator 120, 121a and 121b. In the case of piezoelectric actuator 120, a control signal is generated for each piezoelectric stack.

The position of the mirror 106c is measured by an encoder 122. The encoder 122 comprises at least one scale 123 attached to the mirror 106c and corresponding scale reader(s) 124 attached to a mounting element. Movement of the mirror 106c results in movement of the scale 123 which is read by the scale reader 123 and the resultant signal is sent to controller 139.

In one embodiment, the apparatus comprises multiple lasers 105 and a corresponding scanner 110 for each laser 105. In this way, multiple laser beams can be simultaneously scanned across the powder bed in accordance with the scan path(s) described below.

A master controller 140 may control the modules of the powder bed fusion apparatus based on a build file loaded onto the master controller 140. The build file may be generated by build preparation software running on a computer separate from the powder bed fusion apparatus.

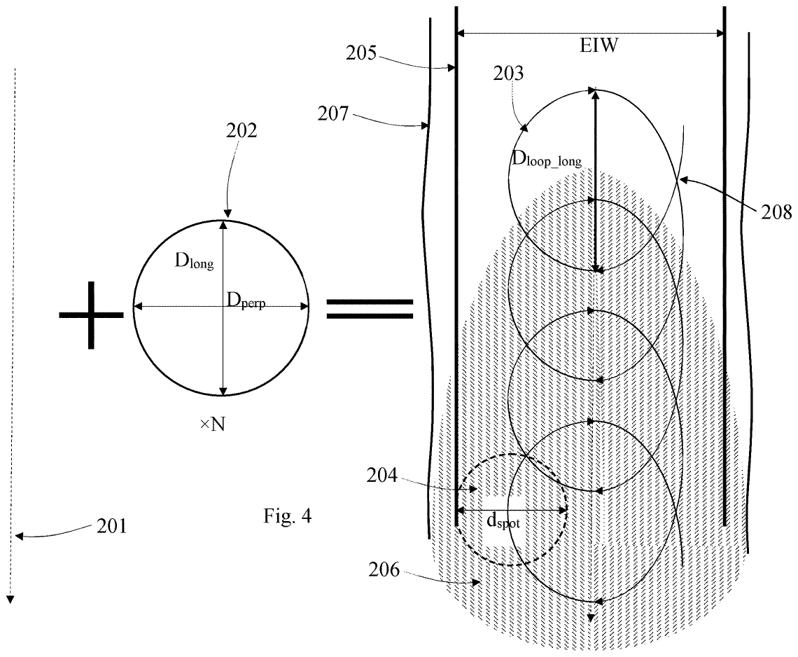

The powder bed fusion apparatus is programmed to control the scanner 110 such that laser beam is scanned across the working plane following a scan path 203 comprising a series of offset loops, wherein ones of the loops intersect. An example of such a scan path is shown in FIG. 4. Each loop is formed by the scan path crossing itself at a crossing point 208 to form a convex shape. Such a scan path 203 may be achieved by the galvanometers 121a, 121b moving mirrors 106a, 106b to move the laser beam 118 in an advancing direction 201 and the actuator 120 moving mirror 106c to superimpose on this movement a circular or elliptical motion 202 of the laser beam 118, which is repeated multiple times, N, as the laser beam 118 is advanced in the advancing direction 201. Movement of the laser beam 118 along the scan path 203 irradiates areas of the powder bed within an irradiation track 205 having a width (referred to herein as the effective irradiated width (EIW)) corresponding to a diameter dₚₑᵣₚ of the circular or elliptical oscillatory motion 202 perpendicular to the advancing direction 201 plus the 1/e² laser spot diameter dₛₚₒₜ.

The laser beam preferably produces a laser spot 204 rather than having another profile and typically has a Gaussian intensity profile. The laser spot diameter dₛₚₒₜ may be between 60 μm and 120 μm. The diameter dₚₑᵣₚ of the circular or elliptical oscillatory motion 202 may be between 150 μm and 300 μm. Accordingly, the laser spot diameter dₛₚₒₜ may be sufficiently small that a centre of each loop is not irradiated when the laser beam is scanned along that loop. However, that region may be irradiated when the laser beam is scanned along one or more of the intersecting loops. A melt pool 206 formed by the irradiation of the powder bed 104 surface may be larger than the irradiated area (the irradiation track), as schematically illustrated in FIG. 4. Accordingly, a consolidated (melt pool) track 207 of solidified material may be wider than the irradiation track 205.

In another embodiment, a larger diameter dₚₑᵣₚ of the circular or elliptical oscillatory motion 202 may be used, such as a diameter between 150 μm and 1 mm.

In FIG. 4, the advancing direction 201 is shown as a straight line, however it will be understood that this is not essential and the advancing direction may be a curved line.

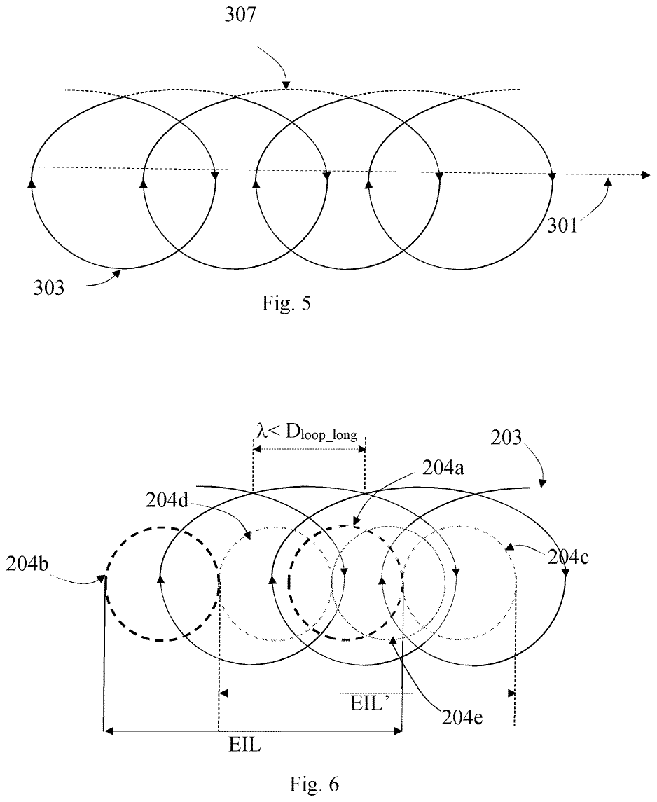

A frequency at which the series of loops are scanned by the laser beam 118 is such that, when scanning at rear stoke of each of a plurality of the loops, the laser beam 118 inputs energy into a molten area melted by the laser beam 118 when scanning an earlier loop in the scan path 203. The frequency is 1/T, wherein T is the time period the fast actuator, in this case the piezoelectric actuator 120, takes to complete one rotation of the circular or elliptical motion 202. In this embodiment, the laser beam 118 is generated continuously for multiple cycles of the circular or elliptical motion 202 so as to produce a continuous scan path 203. However, it will be understood that in another embodiment, generation of the laser beam 118 may be interrupted during each cycle to form gaps within the scan path 203. For example, a scan path 303 shown in FIG. 5 may be produced wherein a gap (indicated by the dotted lines) is provided in the scanning of the laser beam at a bridging section 307 between each loop. This may be advantageous as it may avoid or mitigate effects of more energy being input into the region of the bridging section 307 than other sections of the loop if the bridging section 307 is scanned by the laser beam 118. Furthermore, rather than the laser beam 118 being turned off completely during the bridging section 307, a power of the laser beam 118 may be reduced during scanning of the bridging section 307 compared to scanning other portions of the scan path 303.

Changing an advancing speed of the laser beam 118 in the advancing direction or a frequency of the loops in the scan path 203 alters a wavelength of the loops (λ=v/f, wherein v is the average speed over a loop of the laser beam 118 in the advancing direction (referred to herein as the “advancing speed”) and f is the frequency of the loops. The instantaneous scan speed of the laser beam in the advancing direction may be faster or slower than the advancing speed). FIG. 6 illustrates an example of the scan path 203 wherein the wavelength, λ, of the scan path 203 is less than a diameter of the loop in the advancing direction (referred to herein as the longitudinal diameter, D_{loop_long}, of the loop (this dimension is shown in FIG. 4)). In such a scenario, a central line of the scan path (which is the line shown in FIG. 6) intersects and passes into at least the immediately preceding adjacent loop and possibly, multiple preceding loops. Dotted circles 204a to 204e indicate the extent of the laser spot at diametrically opposed points on each loop. With such an arrangement of loops, the effective irradiation lengths EIL, EIL′ of the loops overlap. The effective irradiation length of a loop is the longitudinal diameter, D_{loop_long}, plus a diameter of the spot, dₛₚₒₜ. When a previously irradiated region, such as at least a portion of laser spot 204a, is irradiated again will depend on the wavelength, λ, the longitudinal diameter, D_{loop_long}, and a diameter of the spot, dₛₚₒₜ. In certain instances, a previously irradiated region may be irradiated again within the time period (T=1/f) of a single loop and in other instances a previously irradiated region may be irradiated again within 3/2 of a time period (T=1/f) of single loop (as is illustrated in FIG. 6, wherein region 204d irradiates a portion of region 204a) or even within 5/2 of a time period (for example, a further portion of region 204a is irradiated again when spot 204e is irradiated). The wavelength (advancing speed and frequency) may be selected such that at least a portion, and possibly all, of a region 204a-204e is irradiated again within a set period of time, such as before a melted region becomes fully solidified. Molten or partially molten material may more readily absorb laser light than more reflective solidified material. Inputting energy into already molten or partially molten material may be important in deepening the melt pool, and therefore allowing the processing of thicker layers, compared to reforming the melt pool. At advancing speeds of 0.5 m/s and a longitudinal diameter, D_{loop_long}, of greater than 100 μm (larger than dₛₚₒₜ which is typically 60-100 μm) a frequency of at least 5 kHz is required. Even at this frequency, 5/2 of the time period is 500 μs, which may be too slow for a region to be irradiated again whilst it is still molten. Accordingly, frequencies above 8 kHz may be preferable such that 5/2 of the time period is around or less than 300 μs. Frequencies above 10 kHz may be preferable such that 5/2 of the time period is less than 250 μs. Operating at higher frequencies will also allow faster advancing speeds, such as 0.7 m/s or more, to be used whilst keeping the wavelength less than a longitudinal diameter, D_{loop_long}, of the loops.

For the loop, the longitudinal diameter of the loop D_{loop_long} is shortened from the diameter of the circle or ellipse defined by the travel of the piezoelectric mirror by

$$\frac{ν}{2 T} = \frac{λ}{2}$$

and hence:

$${D}_{loop \_ long} = {D}_{l o n g} - \frac{λ}{2}$$

Accordingly, the condition in FIG. 6 may be met when

$$λ < \frac{2}{3} {D}_{l o n g} .$$

Accordingly, for D_{long}=150 μm and an advancing speed of above 0.5 m/s a frequency of above 5 kHz is required.

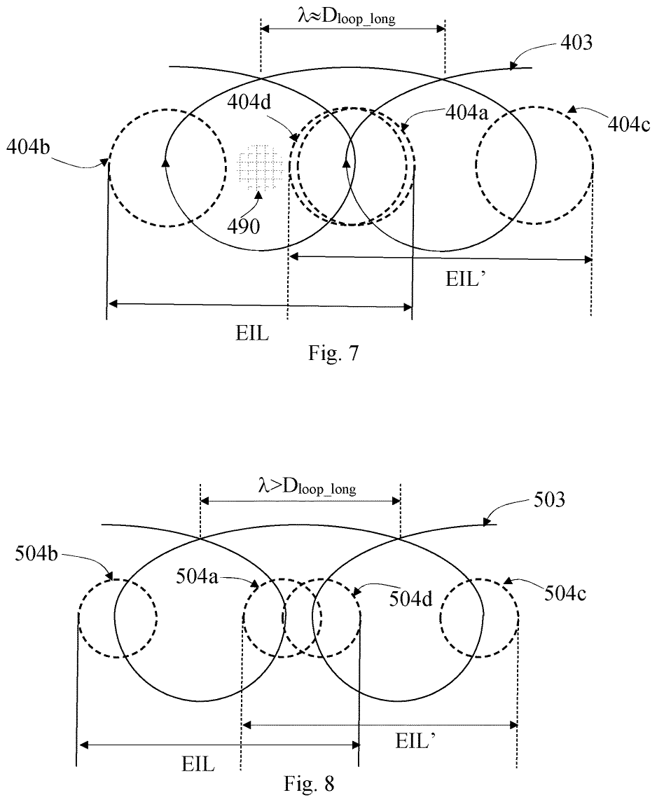

FIG. 7 illustrates an example of the scan path 403 wherein the wavelength, λ, of the scan path 403 is substantially equal to a longitudinal diameter D_{loop_long} of the loop in the advancing direction. The loops of the scan path 403 are still considered intersecting because there is an overlap of the effective irradiation lengths EIL, EIL′ of adjacent loops. Depending on a size of the spot diameter to loop diameter, such as the longitudinal loop diameter, a region 490 within the loop may not be irradiated. For example, in scans given below wherein the loop diameter is 169 μm and the spot diameter is 100 μm, when the wavelength, λ, of the scan path 403 is substantially equal to a diameter of the loop in the advancing direction, a region within the loop that is not irradiated. However, an extent of the melt pool may be greater than the effective irradiation region/length such that all the powder within the track is melted including regions 490.

FIG. 8 illustrates an example of the scan path 503 wherein the wavelength, λ, of the scan path 503 is greater than a longitudinal diameter D_{loop_long} of the loop in the advancing direction. The loops of such a scan path 503 are still deemed to be intersecting if the effective irradiation lengths of adjacent loops overlap (as is shown in FIG. 8). In all of the above-described embodiments, the wavelength, λ, is less than the effective irradiation length EIL, EIL′ (D_{long_loop}+dₛₚₒₜ).

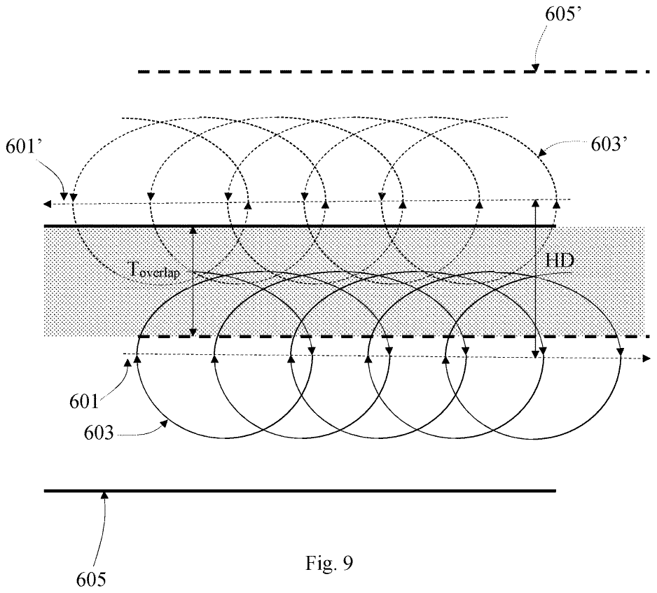

Referring to FIG. 9, to consolidate an area of the powder bed 104 that is larger than the irradiation/consolidated track 605, multiple tracks 605, 605′ may be scanned by the laser beam 118, wherein adjacent tracks 605, 605′ overlap (i.e. the effective irradiation widths EIW of the adjacent scan paths 603, 603′ overlap). Typically, the adjacent tracks are hatch lines of a raster scan or of a stripe of square of a chequerboard scan pattern. The extent, Tₒᵥₑᵣₗₐₚ, of the track overlap is set by setting a hatch distance HD between centres of adjacent tracks 603, 603′. In this embodiment, a track overlap between adjacent scan paths 603, 603′ is between 10% and 40% of an effective irradiated width EIW of the scan paths.

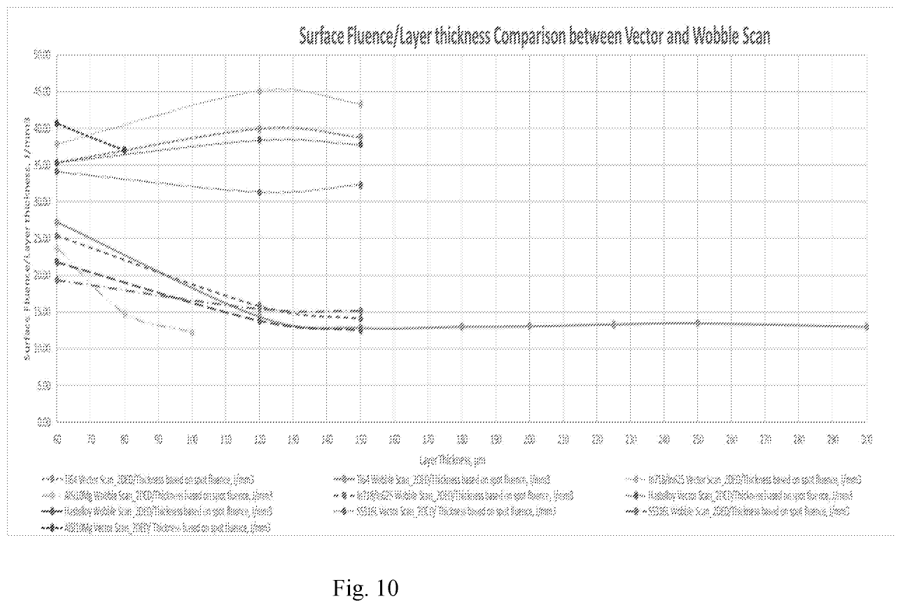

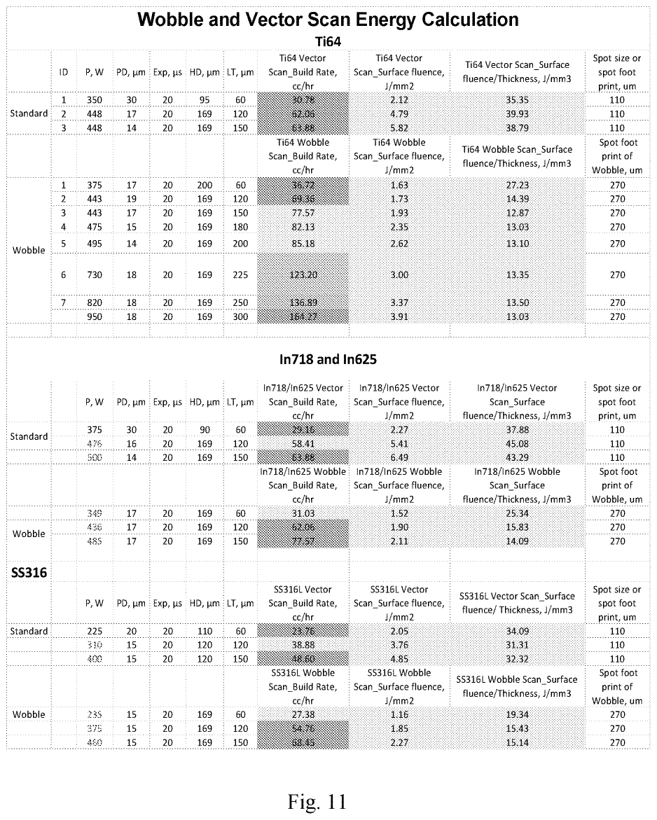

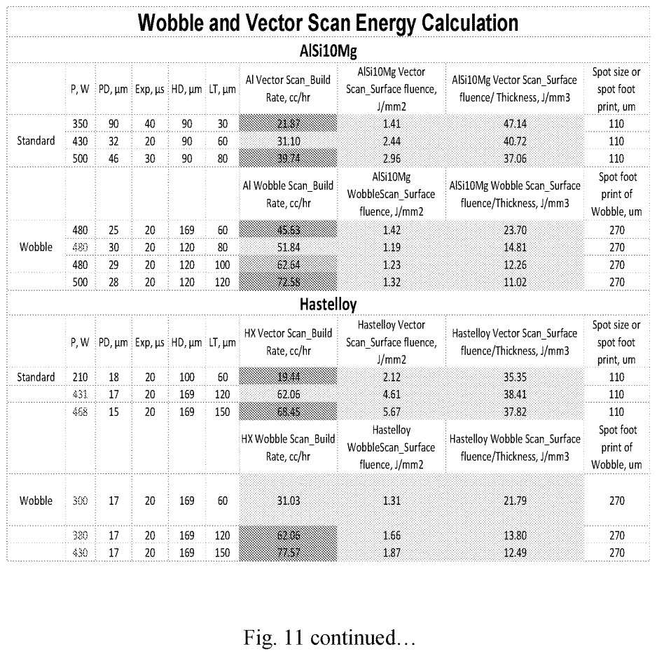

Referring to FIGS. 10 and 11, a number of conventional vector scans and trochoidal scans (referred to as “wobble” scans) were carried out on different materials for a range of different layer thicknesses. The scan parameters were selected such that a bulk density of at least 99.5% was achieved. The selected scan parameters for each layer thickness are shown in the table of FIG. 11. The table also includes a surface fluence (2D energy density) calculated from the scan parameters. The surface fluence achieved by the scan for a constant laser power is defined as:

$$surface fluence = \frac{Laser power \times time to scan track}{track area}$$

If the effective track width remains unchanged during the scan (as is the case for the wobble of FIGS. 10 and 11) then this can be rewritten as:

$$surface fluence = \frac{1 D E D}{effective irradiation width}$$

wherein 1DED is the 1-Dimensional energy density. For scans with a constant scan speed in the advancing direction, the 1DED may be defined as:

$$1 DED = \frac{Laser power}{advancing speed}$$

For scans defined by a point distance and exposure time, as is the case in Renishaw's RenAM additive manufacturing machines, the advancing speed is calculated by:

$$advancing speed = \frac{point distance}{e x p osure time}$$

For all of the wobble scans, the frequency was set at 25 kHz, the diameter D_{long}, Dₚₑᵣₚ of the circle on the powder bed described by the movement of the piezoelectric actuated mirror without movement of the galvo driven mirrors was set at 169 μm and the laser spot size was 110 μm. For the vector scans, the diameter of the laser spot was 80μ m.

FIG. 10 is a plot of surface fluence/thickness (volume energy density) versus thickness for the scans in the table of FIG. 11. As can be seen, for each material, this value for the wobble scans is less than the corresponding value for the vector scans. In other words, a lower surface fluence is required for each layer thickness for a particular material for wobble scans compared to vector scans. Furthermore, for all scans the value of surface fluence/thickness steadily falls until reaching a substantially constant value at a layer thickness between 120 μm and 150 μm. Accordingly, it is believed that vector scans cannot produce like material properties (and possible even fully melt material throughout the layer thickness) for any thickness at the low values of surface fluence/thickness at which this is achievable using wobble scans. Lower levels in the rate of change of surface fluence with layer thickness means that increases in layer thickness do not require such a large increase in surface fluence (2DED) for wobble scans as compared to vector scans meaning that lower surface fluence levels can be used for wobble scans as the thickness of the material increases. This reduction in surface fluence will reduce vaporisation and/or dispersion of powder, improving the passage of the laser beam, and avoiding the formation of unstable keyholes, which may result in porosity.

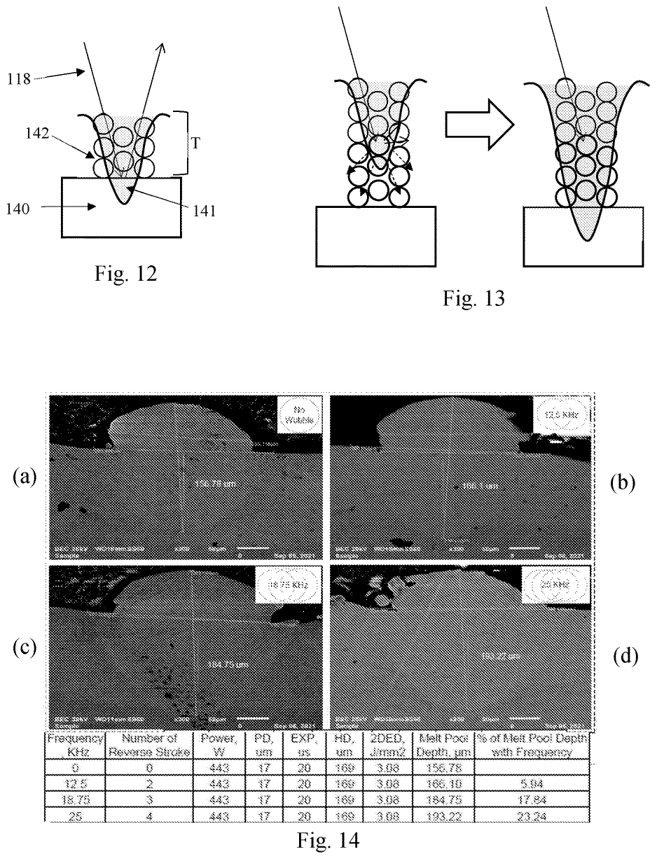

A possible explanation for this difference in value for surface fluence/thickness for vector scanning as opposed to wobble scanning is how a melt pool of sufficient depth is formed. This is illustrated in FIG. 12 for vector scanning and FIG. 13 for wobble scanning. For vector scanning, the surface fluence must be sufficient to form a melt pool having a depth greater than the layer thickness, T. To do this the laser beam will typically penetrate through the powder layer to solidified material 140 below. The solidified material is more reflective than the powder material and thus a significant proportion of the laser beam will be reflected from the solidified material and will not be absorbed by the powder material. For wobble scanning, the surface fluence can be below that sufficient to form a melt pool of the required depth on a first pass over the powder. This is shown in FIG. 13. As the laser beam 118 does not penetrate to the solidified material 140 below, the laser beam is not reflected by the more reflective solidified material but is scattered by the powder 142. In this way, a greater proportion of the laser beam 118 is absorbed and a melt pool 141′ is formed. On a rear stroke of the laser beam 118 along a loop, the laser beam irradiates melt pools formed by a first pass of the material on a fore stroke of a previous loop. The molten or partially molten material absorbs the laser beam more readily than solidified material. The scanning of the already formed melt pool, deepens the melt pool to a required depth. Again, it is believed reflection of the laser beam is reduced compared to single pass scans. As a result, a value of surface fluence per thickness of layers can be reduced compared to single pass scans. This reduction in surface fluence reduces instabilities and thus reduces ejection of material during the melting process and collapse of keyholes in melt pools that can result in porosity. Thus, with wobble scans it is possible to process thicker layers without adversely affecting the resultant solidified material.

Yet further, for wobble scans the spot is moving more quickly over the powder bed (higher scan speed) than for vector scans and therefore, the energy that a region of the powder bed receives per second is lower than for vector scans even if the laser power is the same or higher (the dwell time is lower for wobble scans). This reduces the chance of vaporisation of material and the formation of unstable keyholes. It is believed a required depth of the melt pool is achieved because the laser beam is rescanned over a region at a later time delivering further energy to a region to deepen the melt pool. Between the scans of a powder region, heat from the initial scan can partially dissipate into the surrounding powder material (mainly through conduction) before the next input of energy. In this way, formation of a melt pool in the keyhole mode may be avoided. This may explain why thicker layers can be processed using wobble scans without creating conditions that would result in increases in porosity of the part.

Wobble scans were carried out at different frequencies for Ti6Al4V, wherein the remaining scan parameters are kept constant (Power=443W, point distance=17 μm, exposure time=20 s, Hatch distance=169 μm, layer thickness=150 μm). Melt pool depths were measured from the images (shown in FIGS. 15(a) to 15(e)) and an average melt pool depth for each frequency calculated. FIG. 15(a) is for 25 kHz, FIG. 15(b) is for 20 kHz, FIG. 15(c) is for 15 kHz, FIG. 15(d) is for 10 kHz, and FIG. 12(e) is for 5 kHz. As can be seen in the table of FIG. 15(f), the higher the frequency, the deeper the average melt pool. This result is also supported by the images and data provided in FIG. 14. Furthermore, as can be seen from the images 15(a) to 15(e), the resultant microstructure is different for the different frequencies. The higher frequencies resulted in more isotropic grains, whereas the lower frequencies resulted in more columnar grains.

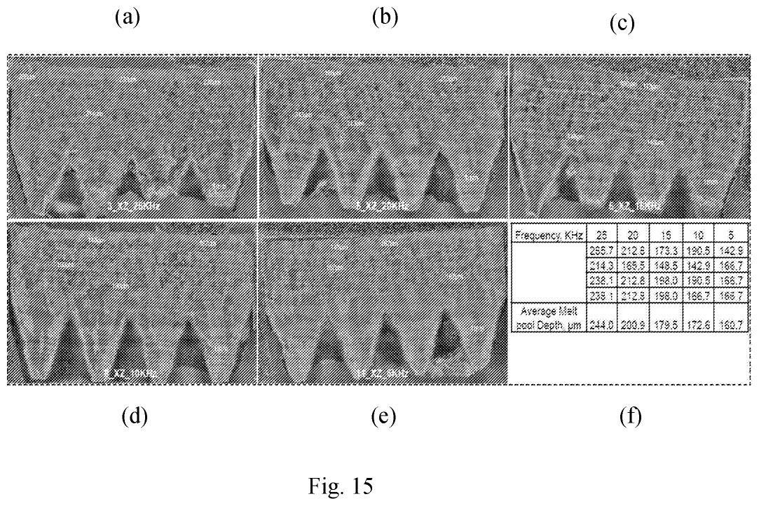

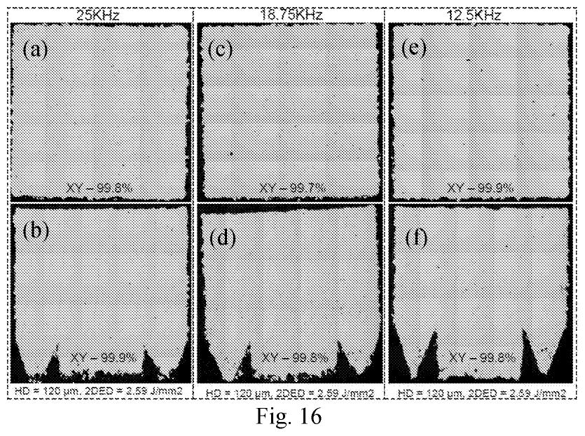

FIG. 16 shows images of solidified material for wobble scans at 25 kHz, 18.75 kHz and 12.5 kHz, the images illustrate that good density is achieved in all cases. The single tracks were scanned over 60 μm powder layer thicknesses.

A number of wobble scans were carried out wherein the point distance was changed to alter the advancing speed. This was carried out for two layer thicknesses, 120 μm and 150 μm for samples S1 to S42. The scan parameters are shown in the table in FIG. 17b. The frequency of the wobble scans was 25 kHz. The total density, bulk density, border density and hardness were measured for the samples. The results of these measurements are shown in the table of FIG. 17a. As can be seen from the table, at advancing speeds of 0.5 m/s, 0.6 m/s and 1.15 m/s, the total and bulk densities drop below 99.5%. For the lower scan speeds of 0.5 m/s and 0.6 m/s, this can be explained as there being excessive energy creating keyhole porosity. For the higher speed scan of 1.15 m/s the reason for poor density is believed to be because there is insufficient energy to reliably melt the powder (lack of fusion).

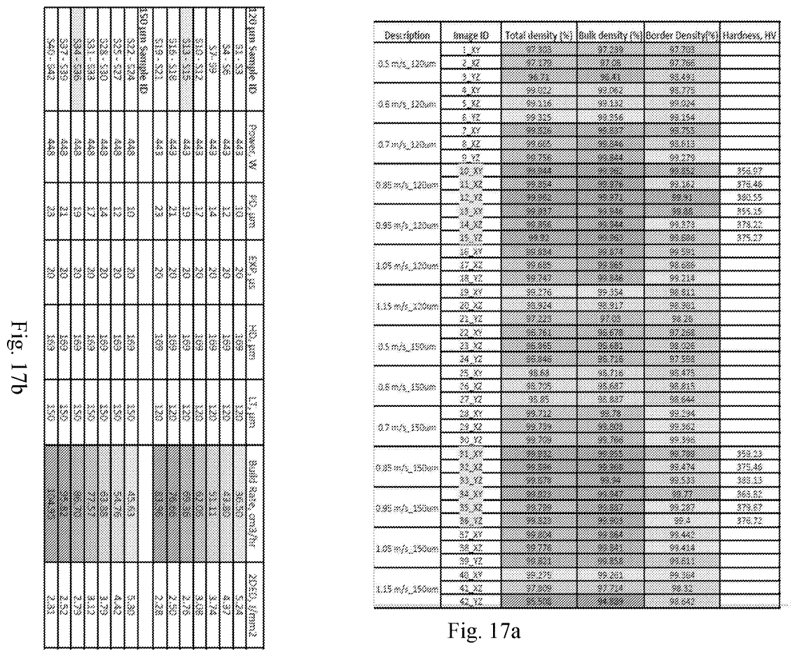

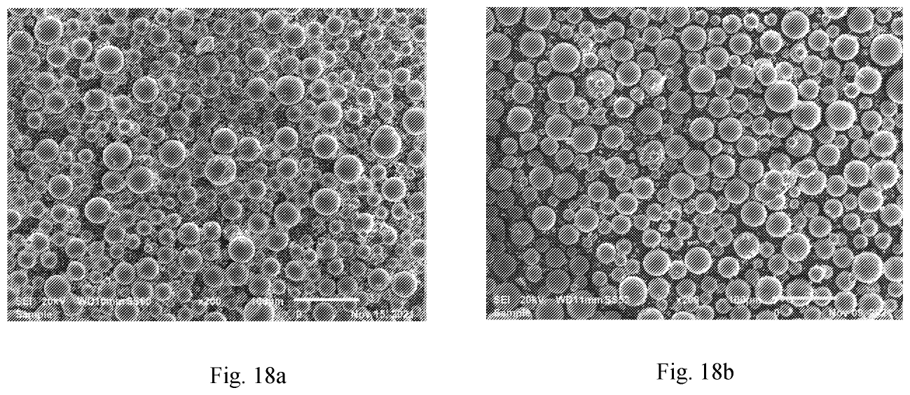

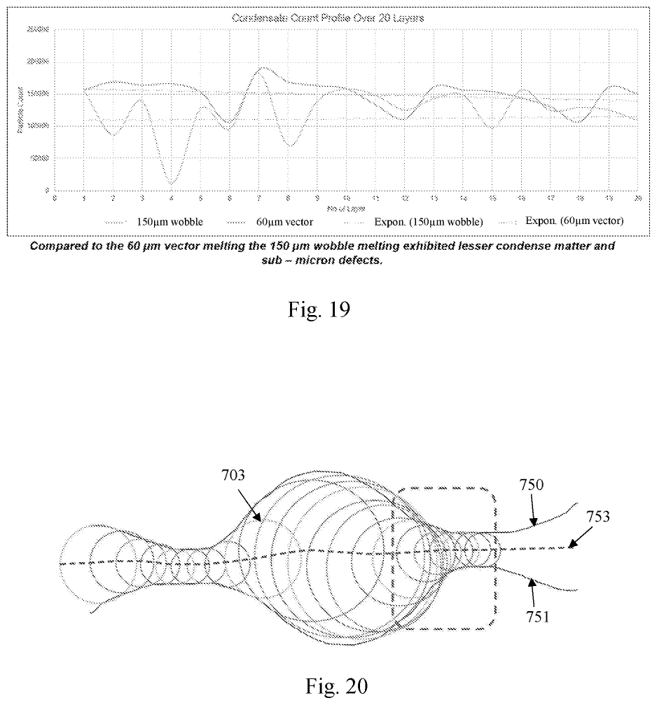

FIG. 18a is an image of captured condensate at the end of a build carried out using vector scans on layer thicknesses of 60 μm and FIG. 18b is an image of captured condensate at the end of a build carried out using wobble scans on layer thicknesses of 150 μm. A high concentration of submicron particles was observed for the vector scans compared to the wobble scans, as can be seen from the images in FIGS. 18a and 18b. This is in line with the particle data count of condensate over 20 layers, shown in FIG. 19. It is believed that the lower level of condensate is a result of the gradual formation of a melt pool with the required depth for wobble scans compared to the “single shot” formation of the melt pool using vector scanning. It is believed that wobble scanning reduces condensate by up to 70% compared to vector scanning of a build of the same material having the same layer thickness.

In one embodiment of the invention shown in FIG. 20, for scan paths 703 near at least one border 750, 751 of a part, a diameter, Dₚₑᵣₚ, of the loop is changed based on a distance at least one border 750, 751 is from a centre 753 of the track (the centre 753 corresponding to a path the laser beam would take under the control of the galvanometers if the oscillating movement caused by the fast actuator, in this embodiment, the piezoelectric actuator is not superimposed on top, e.g. the fast actuator was kept in its neutral position when no voltage is applied). In this way, fine surface detail can be achieved. For a border scan, the centre 753 of the track may not be a line (as may be the case for a hatch scan used to consolidate material within a core of an area) but may be a curve derived from a shape of the border of the part. FIG. 20 shows a uniform change in all diameters of each loop. However, it will be understood that the change in diameter may be a greater change in a diameter transverse to the advancing direction, such as a perpendicular direction Dₚₑᵣₚ, than a diameter in the advancing direction, D_{long}.

In a further embodiment of a scan path 803, illustrated in FIG. 21, a diameter of each loop in the advancing direction may be altered and/or greater than the diameter perpendicular to the advancing direction. Such a shape of the loops may help to elongate the melt pool in the advancing direction 801 increasing a surface area of the melt pool. A melt pool with increased surface area may cool more quickly. This may be used to prevent undesirable heat build-up in an area of the part, such as a narrow section, for example close to a corner of an area, to be solidified.

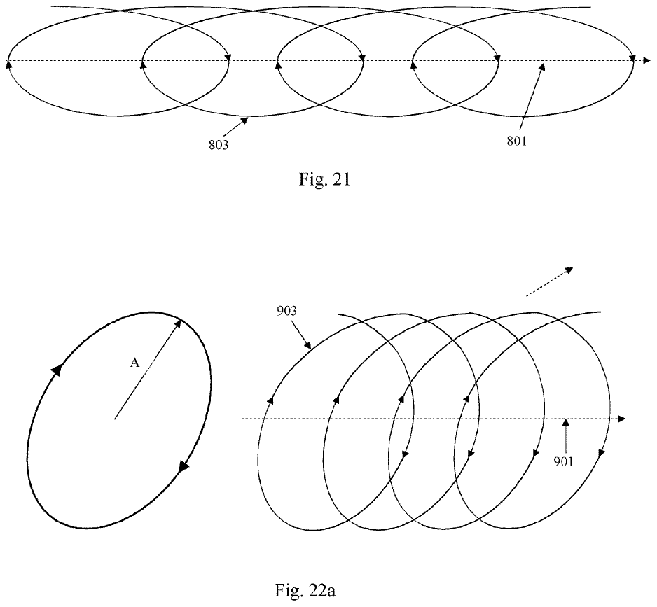

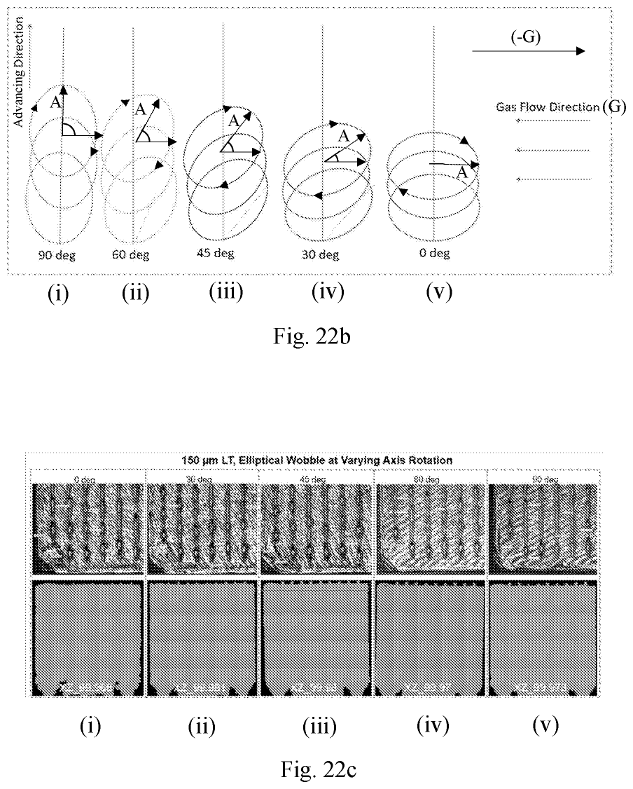

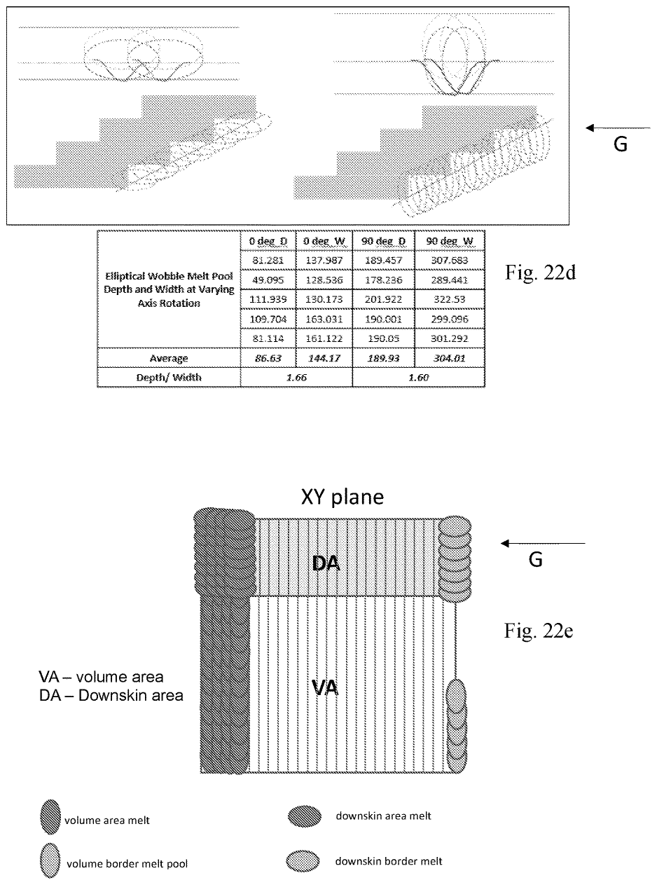

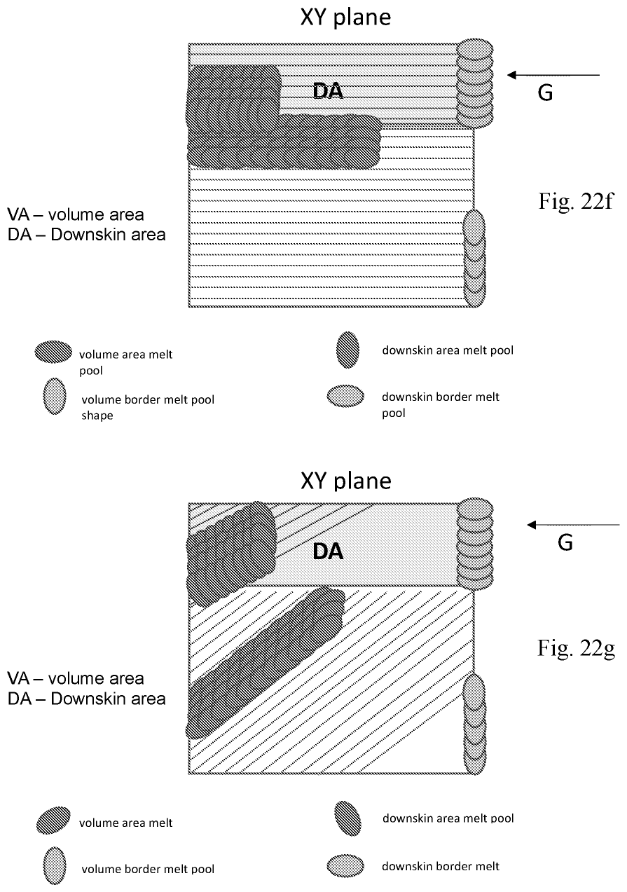

In a further embodiment of a scan path 903, illustrated in FIG. 22a, each loop is formed by elliptical or oval movement of the laser beam 118 superimposed on movement in the advancing direction 901, wherein a major axis of the elliptical or oval movement is transverse to the advancing direction 901. This may alter a cooling profile of the melt pool, favouring heat flow in a direction having a component in the advancing direction and that of the major axis (as shown by the dotted arrow in FIG. 21). This may have advantages in directing heat away from hotter regions of a part and/or to prevent undesirable heat build-up in an area of the part to be solidified. A direction A can be defined along the major axis of the ellipse that has a component in the advancing direction.

Referring to FIG. 22b, in one embodiment, an orientation of the elliptical or oval movement is selected based on a gas flow direction, G. A direction of the loop defined by direction A is such that direction A is opposed to the gas flow direction G (or in other words is between 90° and −90° to the −G direction). FIG. 22 illustrates the advancing direction being perpendicular to the gas flow direction G. However, it will be understood that the advancing direction may be at other angles to the gas flow direction and it is typical to rotate the advancing direction between layers. Scans were carried out for the five arrangements shown in FIG. 22b, (i) direction A at 90° to the −G direction, (ii) direction A at 60° to the −G direction, (iii) direction A at 45° to the −G direction, (iv) direction A at 30° to the −G direction, and (i) direction A at 0° (i.e. parallel) to the −G direction. The ratio of the minor axis to the major axis was 1:1.3 (10:13). FIG. 22c shows images of the samples produced. The tracks produced using ellipses having a direction A between 45° and 90° appeared to produce more consistent tracks (a smaller variation in peak to trough along the track). FIG. 22d illustrates melt pool depths and widths measured for different orientations of the elliptical loops relative to the gas flow. As can be seen, the average melt pool depth and width for elliptical loops with a major axis 0° to the negative gas flow direction (−G) are smaller than the melt pool depth and width for elliptical loops with a major axis 90° to the negative gas flow direction (−G). Accordingly, in one embodiment a direction A of the ellipses is arranged to be between 45° and 90° and −45° and −90° to the −G direction (and hence an advancing direction must be between −90° and 90° to the −G direction. In another embodiment, the advancing direction is not limited to having a component in the −G direction (opposed to gas flow) and a direction A of the ellipses is arranged to be between 45° and 135° and −45° and −135° to the −G direction. It may also be preferable that the advancing direction is between 45° and 135° and −45° and −135° to the −G direction. For example, in short hatches of a stripe, it may be preferably that the hatches are oriented between 45° and 135° and −45° and −135° to the −G direction (and optionally that a stripe formation direction perpendicular to the hatches has a component in the −G direction (is opposed to gas flow)). Accordingly, the direction A may need to be less than 90° to the advancing direction such that both the advancing direction and the direction A are oriented between 45° and 135° and −45° and −135° to the −G direction. The direction A of the ellipses may be changed between layers, between stripes of a stripe scanning strategy or between squares of a chequerboard scanning strategy.

FIGS. 22e to 22g is a schematic of areas to be solidified comprising a downskin area DA and a volume area VA. A downskin area DA may be determined from the number of the solidified layers below each region of the area. If a number of solidified layers below the region is below a predetermined threshold, then the region is considered part of the downskin area and if the number of solidified layers below the region is equal to or above a predetermined threshold then the region is considered part of the volume area. The area is solidified by one or more border scan paths that runs around the periphery of the area and a fill scan that solidifies material within the border scan path(s). The fill scan comprises hatch lines that extending across the volume area(s) and hatch lines extending across the downskin area(s). As can be seen from FIGS. 22e to 22g a direction of the hatch lines may be altered between layers. For volume area fill scans, an orientation of the major axes of the elliptical loops is along of the hatch line. For downskin fill scans, an orientation of the major axes of the elliptical loops is perpendicular to the hatch lines. However, the major axes of the elliptical loops for the downskin area border scan paths are aligned opposed to the gas flow direction and the major axes of the elliptical loops for the volume area border scan paths are aligned perpendicular to the gas flow direction. This may facilitate cooling and smaller melt pools are formed in the downskin areas compared to the volume areas. Facilitating cooling of melt pools within the downskin areas may be desirable to mitigate the poorer thermal conduction from the downskin areas. The shallow melt pools may improve a surface finish within the downskin areas.

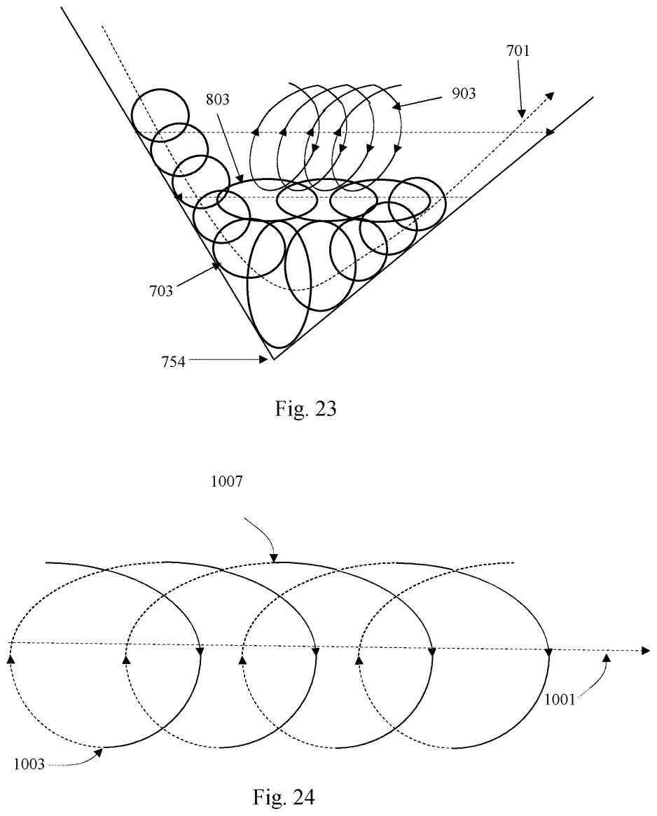

FIG. 23 illustrates how such scan paths 703, 803, 903 may be arranged relative to a narrow region within an area to be solidified, in the case a corner 754. For scan path 703, the slower actuators move the laser beam along a border path 701 that has an appropriate curve at the corner 754 that is achievable using the dynamic response of the slower actuator. The faster actuator superimposes on the movement of the slower actuators, a circular motion but changes a diameter of the circular motion to compensate for changes in a distance of the intended surface of the part from the border scan path 701. For scan path 803, corresponding to a hatch line for solidifying a core of the area, the major axis of the circular motion is oriented along the advancing direction to prevent or reduce heat build-up in the corner of the area. Similarly, for scan path 903, the major axis of the loops is oriented to favour cooling in a direction away from corner 754.

In a further embodiment, a power of the laser beam is changed as the laser beam is scanned around each loop. FIG. 24 shows a scan path wherein regions illustrated with solid lines are scanned at a higher laser power than regions illustrated with dotted lines. In this embodiment, a fore stroke of each loop is scanned with a laser power different to an aft or rear stroke. In particular, it has been found that determining a number of times each region of powder is scanned and simply dividing the typical power delivered using a “single shot” during vector scanning by the number of times a region is scanned does not produce good results. For example, if it is deemed that regions are scanned twice, once on a fore stroke and once on a rear stroke then simply halving the power that is normally used in vector scanning does not produce good results. It has been found that better results are achieved if at least one of the passes are with a laser power that is at least 70% of the laser power used for vector scanning. This may be the fore or the rear stroke. In the case that it is the fore stroke that is carried out with a laser power that is at least 70% of with laser power used for vector scanning then the rear stroke may be scanned with a lower power. If it is the rear stroke that is scanned with a laser power that is at least 70% of the laser power used for vector scanning, then the fore stroke may be scanned with a power less than 30% the laser power used for vector scanning. Accordingly, in this latter example, a power for the rear stroke would be at least 7/3 of the power of the fore stroke. It is believed that the reason such a ratio is preferable is because if a laser power lower than 70% but above 30% is used for the first pass, the power is insufficient to melt or sinter the powder such that the powder is fixed in place but is high enough to displace powder. Accordingly, using such an intermediate power for the first pass displaces the powder away from the region such that insufficient powder is present for the second pass to form a layer of the required thickness. For powers below 30% of the laser power used for vector scanning, the laser beam simply preheats the powder but does not displace the powder. Accordingly, a ratio of laser power for a rear stroke to laser power for a fore stroke may be at least 7:3 or less than 3:7.

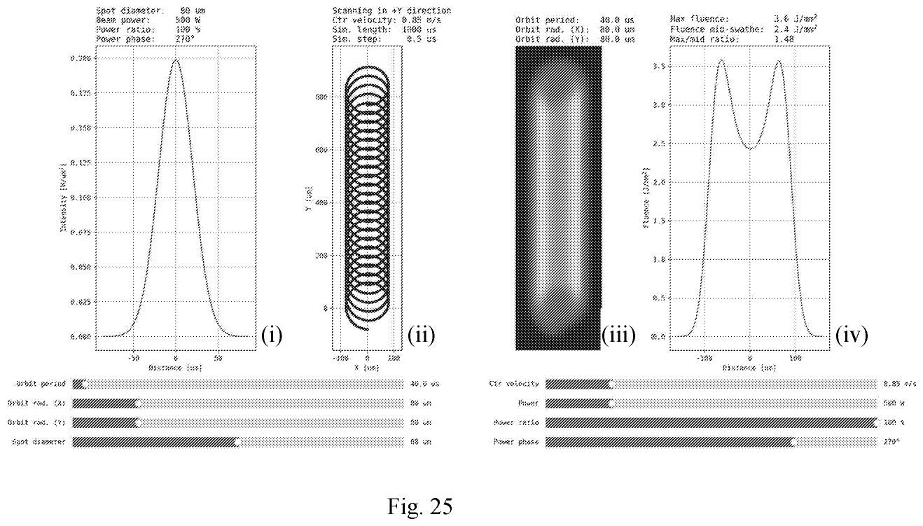

Laser power around a loop may be changed at other locations to create surface fluence profiles perpendicularly across a track different to that created using a laser with constant power. FIG. 25 shows a surface fluence profile perpendicularly across a track wherein the laser power remains constant for a frequency of 25 kHz, a laser spot diameter of 80 μm, a D_{long} (referred to in FIG. 25 as “Orbit rad (Y)”) and Dₚᵣₑₚ (referred to in FIG. 25 as “Orbit rad (X)”) diameter of 160 μm and an advancing speed of 0.85 m/s. From left to right, i) a graph of the laser beam intensity profile across the laser spot, ii) an image of the scan path, iii) a graph showing a surface fluence on the track and iv) a graph of surface fluence along a perpendicular line though the track. As can be seen form FIG. 25, these parameters result in a U-shaped surface fluence across the track in a direction perpendicular to the advancing direction with equal height peaks.

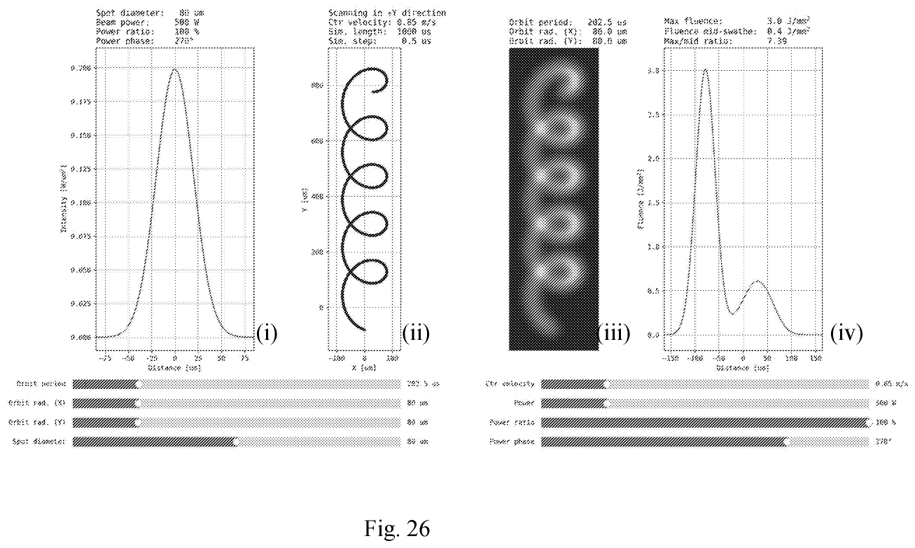

FIG. 26 shows a surface fluence profile perpendicularly across a track for a scan like that shown in FIG. 25 but with a frequency of 5 kHz rather than 25 kHz. As can be seen the loops do not overlap for this set of parameters. These parameters (including a fixed laser power) create a surface fluence perpendicular to the advancing direction that is asymmetrical as shown in FIG. 26(iv).

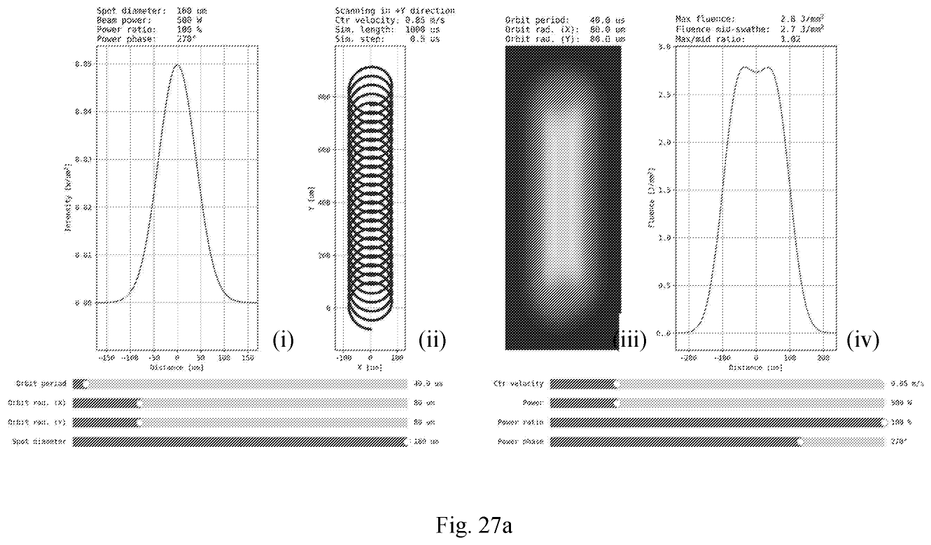

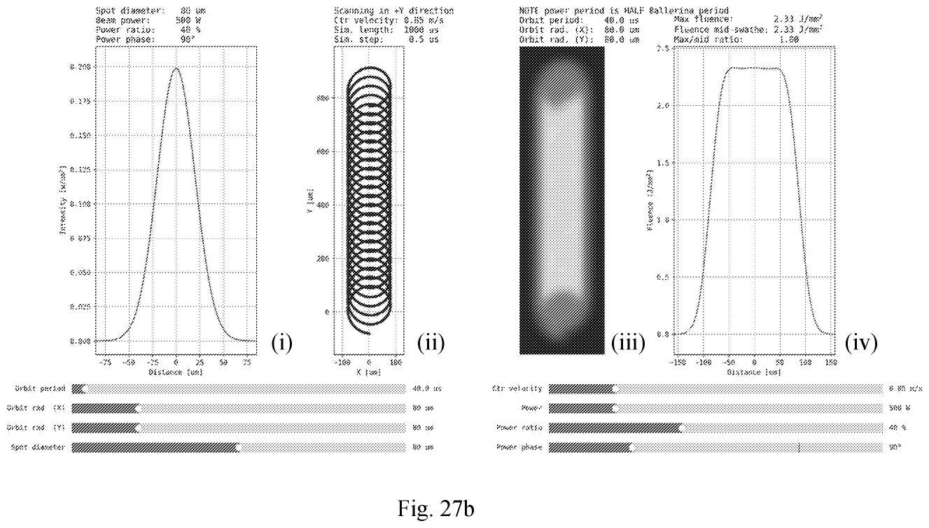

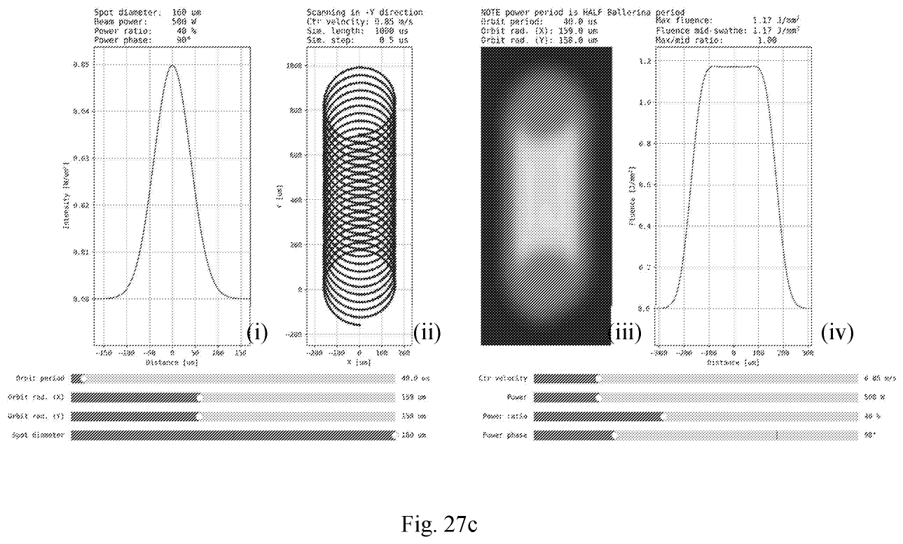

FIGS. 27a to 27c illustrates ways a surface fluence perpendicular to the advancing direction may be altered for a fixed frequency of the loops, in this example 25 kHz. The examples result in flat-topped surface fluence profiles but other shaped surface fluence profiles could be achieved.

In FIG. 27a, a focussing of the laser beam is altered to enlarge the laser spot diameter, dₛₚₒₜ, to 160 μm (so that there is a 1:1 correspondence with the D_{long} and Dₚᵣₑₚ diameter of 160 μm and the diameter of the spot, dₛₚₒₜ). This results in a surface fluence perpendicular to the advancing direction having a flat top profile.

FIG. 27b illustrates an alternative way to create a substantially flat top profile. In this embodiment, the laser power is varied as the laser beam orbits the loop. In the example, the laser beam power oscillates at twice the orbit frequency, peaking at a central axis of the track and having a minimum at the extremes (sides). The laser power ratio between peak and trough is 40%. As can be seen from FIG. 27(iv), this results in a surface fluence perpendicular to the advancing direction having a flat top profile.

FIG. 27c illustrates a further way to create a substantially flat top profile. In this example, a focussing of the laser beam is altered to enlarge the laser spot diameter, dₛₚₒₜ, to 160 μm and a diameter of the orbit a D_{long} and Dₚᵣₑₚ is increased to 300 μm. Compared to the flat top of FIG. 27a, a wider flat top is created with no discernible drop in the surface fluence at the centre of the peak.

The techniques described with reference to FIGS. 27a to 27c may be used to obtain a desired surface fluence profile for a fixed frequency and advancing speed. A flat topped fluence profile may result in a peak in temperature centrally within the track as, despite the uniform surface fluence, the material at the sides of the track may have a faster cooling rate than material centrally in the track because a steeper temperature gradient exists at the sides of the track. A surface fluence with a U-shaped profile may be preferred as a flat-topped temperature profile may be achieved across the track and unnecessary vaporisation of material may be avoided.

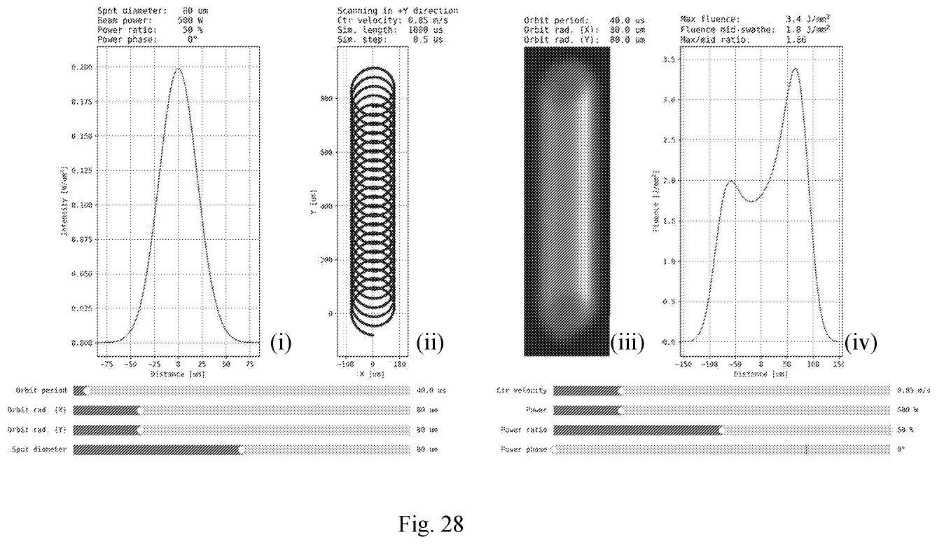

FIG. 28 shows a surface fluence profile perpendicularly across a track wherein the laser power is increased on one side of the loop compared to the other. For example, the higher laser power may be used on a side of the track adjacent colder material, such as powder, wherein the lower laser power may be used on a side the track adjacent hotter material, such as previously solidified material.

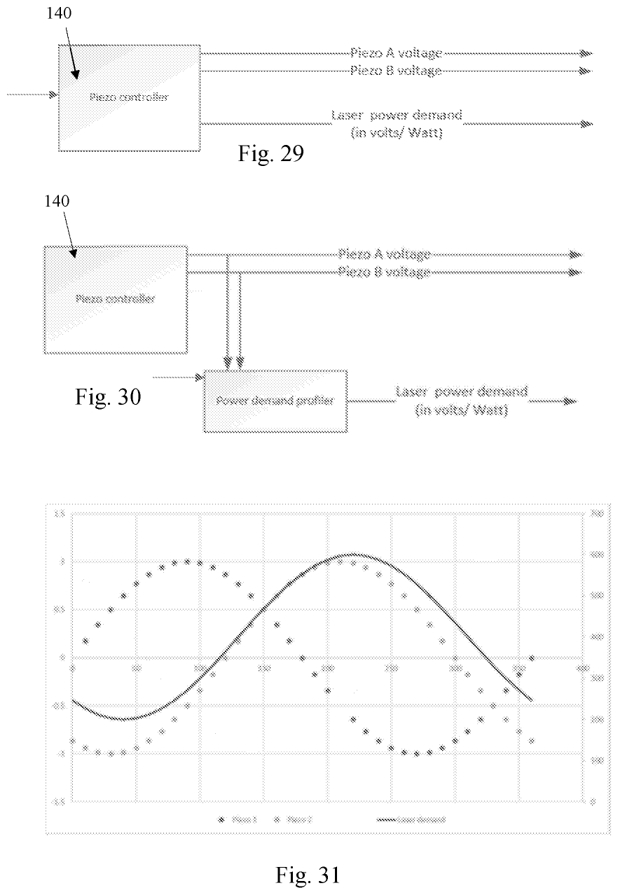

The laser power may be controlled based on control signals sent to the piezoelectric actuators. In particular, a laser demand signal for controlling the power of the laser may be derived from control voltages sent to the piezoelectric actuators (or other fast actuators). Controller 139 may comprise a piezo controller 140 for generating control signals for the piezoelectric actuators 120 of the mirror 106c, as illustrated in FIG. 29. The controller 140 is arranged to generate the control signals, in this example two control signals Piezo A voltage, Piezo B voltage, for the piezoelectric actuators based on the required motion of the mirror 106c to create the desired closed scan path, such as circular or elliptical scan path, on the powder bed (if the galvanometers were kept stationary). In addition the controller 140 generates a laser power demand signal based on the control signals generated for the piezoelectric actuators 120. The laser power signals may be determined using a predefined relationship between the laser power and the piezo control signals, for example defined by an algorithm, function, map or look-up table. The laser demand signal is delivered to the laser. The user may define the relationship between laser power and a control voltage for at least one of the piezoelectric actuators. In this way, the change in laser power is synchronised with the movement of the laser beam caused by tilting of the mirror actuated by the piezoelectric actuators and cycles with the oscillating voltage applied to the actuator. The relationship between the piezoelectric voltage and the laser power demand signal may be set by the user through an appropriate interface/build preparation software. The laser power signals may be based on a control signal for a single piezo actuator used to move the mirror 106c or a plurality of piezo actuators used to move the mirror 106c. The dominance/influence of each piezo control signal on the laser power demand signal may change through a cycle of the mirror 106c and/or over a series of cycles.

FIG. 31 illustrates an example of control voltages for driving the piezoelectric actuators and a laser demand signal that has been derived from the control voltages. As is clear from FIG. 31, the peak of the laser demand signal may be out of phase with the peak in the voltages to the piezoelectric actuators. Furthermore, the laser demand signal may comprise multiple additional peaks for the cycle of piezoelectric actuators if a peak laser power is to be reached more than once during a cycle.

In an alternative embodiment, shown in FIG. 30, rather than the piezo controller 140 being arranged to generate the laser power demand signals, a separate processor 141 (power demand profiler) takes these control signals and interpolates the laser power demand from a pre-programmed algorithm. This embodiment delegates processing time through the system. Furthermore, it may be possible to retrofit such a separate processor 141 to an existing scanner system.

Different relationships between the piezoelectric voltage and the laser power demand signal may be set for different circumstances, such as those described above. Accordingly, the piezo controller 140 and/or the power demand profiler 141 may comprise an input via which the piezo controller 140 and/or the power demand profiler 141 receives a laser power profile signal identifying which relationship (e.g. pre-programmed algorithm) to use to determine a laser power demand. The laser power profile signal may be generated by the master controller 140, for example, based on instructions in the build file.

In an alternative, the laser demand signals are derived from signals from encoder 122.

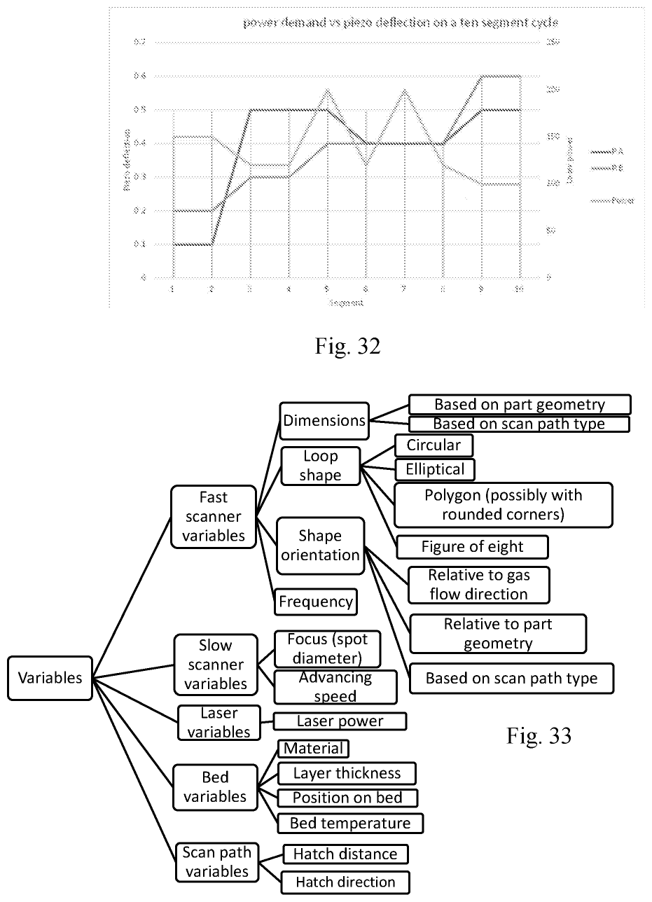

In a further embodiment, the positions of the piezo actuators and laser powers are defined for each of a plurality of segments of a cycle of the actuators. This is illustrated in FIG. 32. A cycle of the mirror 106c is broken up into a plurality of segments, ten in the example shown although in practice the cycle is likely to be divided up into many more segments (hundreds or thousands). For each segment, a position of each actuator is defined, for example in terms of piezo electric voltage and/or deflection. In addition, for each segment, a laser power is defined. For example, the laser power for each segment may be set by a user. The piezo control signals and laser power demand is then driven by time in accordance with a clock signal. The length of the segments in time is dependent on the time period set for the cycle (which is dependent on frequency). Accordingly, the same relationship between laser power and position of mirror 106c will be achieved for different time periods (with the segments becoming longer or shorter based on the time period).

Build preparation software for designing the build may allow for selection of the above parameters of the wobble scan. The parameters may be selected directly by the user or indirectly through selection of a desired outcome. For example, a user may directly select a frequency for the scan or the user may select a desired microstructure and the build preparation software selects a frequency that has been identified as producing such a microstructure. For example, the software may identify a first frequency or first range of frequencies that produce coarse grains, a second frequency or second range of frequencies that produce fine grains. A user may select whether coarse or fine grains are required for the part and the build preparation software selects a frequency based on whether the user has selected coarse grains or fine grains for the part. The first frequency or first range of frequencies, may be between 5 kHz and 10 kHz, and the second frequency or second range of frequencies, may be between 10 kHz and 40 kHz, preferably between 20 kHz and 40 kHz. The software may identify a third frequency or third range of frequencies that produce medium grains. The third frequency of third range of frequencies, may be between 10 kHz and 20 kHz. The user may be able to select whether coarse or fine grains are required for the part and the build preparation software selects a frequency based on whether the user has selected coarse, medium or fine grains for the part. The frequencies may be material dependent, for example based on an estimated solidification rate of the material.

The frequency may also be changed during melting of a layer or between layers.

For example, the frequency may be selected based on geometry of the part and or area to be melted. The frequency may be selected based on a wall thickness. A first frequency, for example between 5 kHz and 10 kHz, may be selected for walls of a first thickness, for example between 0 mm and 1 mm, and a second frequency, for example above 10 kHz and optionally between 10 kHz and 15 kHz, may be selected for walls of a second thickness, for example above 1 mm and optionally between 1 mm and 5 mm. In a further embodiment, a third frequency, for example above 15 kHz, is selected for walls of a third thickness, such as walls above 3.5 mm.

FIG. 33 illustrates variables that may be changed within the apparatus. The variables can be divided into categories based on the module of the apparatus that controls this variable. In FIG. 33, the variables are divided into fast scanner variables, for example variables controlled by controlling action of the piezoelectric actuated mirror; slow scanner variables, for example variables controlled by action of the galvanometer actuated mirrors; laser variables controlled by controlling the laser; bed variables that relate to the powder bed; and scan path variables controlled by build preparation software that plans the scan paths based on part geometry.

The fast scanner variables relate to the shape scanned by the laser beam that is superimposed on the movement of the laser beam by the slow scanner and a frequency at which that shape is scanned. The shape the laser beam is scanned by the fast scanner together with the advancing speed set by the slow scanner sets the shape of the loops. Control of the fast scanner controls the dimensions, shape, and orientation of the loop. Selection of these variables may be based on the geometry of the part being built and the build design. For example, the dimensions of the loop may be based on part geometry, for example, as described above with reference to FIGS. 20 and 23 or a scan path over an overhang region or volume region; and/or scan type, such as whether the scan path is a fill-scan path, border scan path, meander scan path, stripe scan path, chequerboard scan path, a hatch distance between scan paths and/or a scan path direction. The loop shape may be selected, for example, to be circular, elliptical, a polygon (with rounded corners as the fast scanner cannot provide sharp corners due to the mirror inertia) or a Figure of eight or other multi-looped loop shape. The orientation of the shape may be selected, for example based on gas flow direction, based on part geometry and/or based on the scan type (such as those listed above). The frequency of the scan may be selected, for example, to achieve a desired microstructure.

The slow scanner variables are the focus of the laser beam (controlled by movable focussing optics) and the advancing speed of the laser beam along the track. The focus may be altered to change a laser spot size of the powder bed surface. This may be a way of altering the effective irradiation width without altering the shape of the loop. Altering the advancing speed changes the shape of the loop for a set frequency, an amount of overlap between adjacent loops and the surface fluence.

The laser variables comprise laser power.

The bed variables comprise the type of material, a layer thickness, a position of the part on the bed and a bed temperature (which may be controlled by a heater in the build platform and/or walls of the build volume).

The scan path variables include hatch distance and hatch direction are set during the planning of the build.

During build planning these variables are selected to achieve a desired outcome, such a metallurgical outcome such as material density or surface finish, build time, condensate creation or the like. Change in one variable may require a change in another one of the variables because the effects of variables are interrelated. For example, a change in a dimension and/or orientation of the loop may change the effective irradiation width of the track and therefore, a surface fluence. Accordingly, if such a change is made, a corresponding change may be made to the laser power in order that a desired surface fluence is achieved. Furthermore, a change in the effective irradiation width may require a change in hatch distance.

Alternatively or additionally, the effective irradiation width may be maintained by changing the focus of the laser beam (and therefore the laser spot size). A change in frequency may affect the extent of overlap between adjacent loops, changing the resultant microstructure. To maintain the original microstructure, the advancing speed may be changed to compensate for the change in frequency. (A change in advancing speed may require a change in laser power to maintain a desired surface fluence). A change in scan path type may require a corresponding change in shape orientation. A change in bed temperature may alter the required surface fluence and therefore, a change in the variables that influence surface fluence. Altering the layer thickness may require a change in surface fluence in order that the desired volume energy density (surface fluence/layer thickness), such as those illustrated in FIG. 10, is achieved

It will be understood that alterations and modifications can be made to the above-described embodiments without departing from the invention as defined herein. Curves of the loop may include negatively oriented as well as positively oriented curves (defined with respect to an interior of the loop).

1-48. (canceled)

49. A powder bed fusion method comprising scanning a laser beam across a powder bed to melt powder of the powder bed at selected locations, the laser beam scanned along a scan path comprising a series of offset loops.

50. The powder bed fusion method according to claim 49, comprising successively consolidating layers of the powder bed to form a part, wherein the laser beam is scanned along the scan path to consolidate powder of one of the layers having a layer thickness of 80 μm or more, 100 μm or more, or 120 μm or more.

51. The powder bed fusion method according to claim 49, wherein an average surface fluence across the track width and a layer thickness is such that an energy density value of the average surface fluence divided by the layer thickness is less than 30 J/mm³, less than 25 J/mm³ or less than 20 J/mm³.

52. The powder bed fusion method according to claim 49, wherein the powder material is a metal.

53. The powder bed fusion method according to claim 49, wherein a frequency at which the series of loops are scanned by the laser beam is such that, when scanning at least a portion of each of a plurality of the loops, the laser beam inputs energy into a molten or partially solidified area melted by the laser beam when scanning an earlier loop in the scan path.

54. The powder bed fusion method according to claim 49, wherein a frequency at which the series of loops are scanned by the laser beam is 5 kHz or greater, 10 kHz or greater or 12.5 kHz or greater.

55. The powder bed fusion method according to claim 49 comprising altering a frequency of the loops as the laser beam is advanced along the scan path.

56. The powder bed fusion method according to claim 55, wherein the frequency is altered between 5 kHz and 40 kHz, between 10 kHz and 40 kHz, or between 12.5 kHz and 40 kHz.

57. The powder bed fusion method according to claim 49, wherein an advancing speed, v, is greater than 0.5 m/s or greater than 0.7 m/s, the advancing speed defined as a distance between corresponding points of adjacent loops divided by the time taken to scan between the corresponding points.

58. The powder bed fusion method according to claim 57, wherein the advancing speed is less than 1.10 m/s.

59. The powder bed fusion method accordion got claim 49, wherein a diameter of each loop is at least 120% of the diameter of the laser spot.

60. The powder bed fusion method according to claim 49, wherein the laser spot diameter is 60 μm to 110 μm and the diameter of each loop is greater than 100 μm.

61. The powder bed fusion method according to claim 49, comprising altering a diameter of the loops as the laser beam is advanced along the scan path.

62. The powder bed fusion method according to claim 61, wherein the diameter of the loops is a diameter transverse to the advancing direction.

63. The powder bed fusion method according to claim 49, wherein an orientation of major axes of the loops is varied along the scan path.

64. The powder bed fusion method according to claim 49, comprising altering an intensity of the laser beam as the laser beam is scanned around a one of the loops, wherein a higher intensity laser beam is used for a first portion of a loop closer to powder and a lower intensity laser beam is used for a second portion of the loop closer to previously consolidated material.

65. The powder bed fusion method according to claim 49, comprising altering an intensity of the laser beam as the laser beam is scanned around a one of the loops, wherein a higher intensity laser beam is used for outer portions of each loop further from a central axis of a track of the scan path and a lower intensity laser beam may be used for central portions of each loop closer to the central axis.

66. The powder bed fusion method according to claim 49, comprising altering an intensity of the laser beam as the laser beam is scanned around a one of the loops, wherein a higher intensity laser beam is used for a fore stroke of at least one of the loops and a lower intensity laser beam for a rear stroke of the at least one or each of the loops.

67. The powder bed fusion method according to claim 49, comprising controlling a laser power based on a steering optic control signal sent to an actuator for moving a steering optic of a scanner that directs the laser beam to different locations on the powder bed or an encoder signal that measures a position of the steering optic.

68. The powder bed fusion method according to claim 67, wherein the steering optic comprises a movable optic controlled by a second actuator that has a faster dynamic response than a first actuator for moving the or another steering optic for moving the laser beam across the powder bed.

69. The powder bed fusion method according to claim 49 comprising selecting a shape of the loops based on a direction of gas flow across the powder bed.

70. The powder bed fusion method according to claim 69 comprising selecting a direction of a major axis of the or each loop based on the gas flow direction.

71. The powder bed fusion method according to claim 49 comprising scanning the laser beam over a layer along a plurality of the scan paths, wherein, for first ones of the scan paths within a volume area of the layer, a major axis of each loop is at an angle of between −45° and +45° to an advancing direction and, for second ones of the scan paths within a downskin area of the layer, a major axis of the or each loop is between +45° and 135° to the advancing direction.

72. A powder bed fusion apparatus comprising a scanner for directing a laser beam to selected regions of a powder bed and a controller for controlling the scanner, the controller arranged to control the scanner to carry out the powder bed fusion method according to claim 49.

73. A data carrier having instructions thereon, wherein, when the instructions are executed by a controller of a powder bed fusion apparatus, the instructions cause the controller to control a scanner to carry out the powder bed fusion method according claim 49.
